(19) United States
(12) Patent Application Publication
(10) Pub. No.: US 2024/0314738 A1
(43) Pub. Date: Sep. 19, 2024

(54) PAGING METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN)

(21) Appl. No.: 18/674,566

(22) Filed: May 24, 2024

Related U.S. Application Data
(63) Continuation of application No. PCT/CN2021/133846, filed on Nov. 29, 2021.

(51) Int. Cl. H04W 68/02; H04W 24/08; H04W 52/02

(52) U.S. Cl. CPC H04W 68/02; H04W 24/08; H04W 52/0235

(57) ABSTRACT

Provided are a method for paging, a terminal device and a network device. In the method for paging, the terminal device receives first information, which is a low power wake up signal; and the terminal device monitors a paging message in a paging window, where a first start moment of the paging window is determined based on a receiving moment of the first information and a wake up interval.

### CROSS-REFERENCE TO RELATED APPLICATION

This application is a continuation of International Patent Application No. PCT/CN2021/133846 filed on Nov. 29, 2021, the entire contents of which are incorporated herein by reference in its entirety.

### BACKGROUND

The main function of a paging message is to enable a network device to page for a terminal device in a radio resource control idle (RRC-IDLE) state or an RRC inactive (RRC-INACTIVE) state. With development of technologies, power saving of a terminal device is more focused. Therefore, it is proposed such a manner that a terminal device uses a receiver with lower power consumption, namely does not use a master receiver; however, in this manner, how to ensure that a paging message is monitored or received by the terminal device in a timely manner becomes a problem to be solved urgently.

### SUMMARY

The disclosure relates to the field of communications. Embodiments of the disclosure provide a method for paging, a terminal device, a network device, a chip, a computer-readable storage medium, a computer program product, and a computer program, which can at least solve the above problem.

Embodiments of the disclosure provide a method for paging including that: a terminal device receives first information, where the first information is a low power wake up signal; and the terminal device monitors a paging message in a paging window, wherein a first start moment of the paging window is determined based on a receiving moment of the first information and a wake up interval.

Embodiments of the disclosure provide a method for paging including that: a network device sends first information, wherein the first information is a low power wake up signal; and the network device sends a paging message in a paging window, wherein a second start moment of the paging window is determined based on a sending moment of the first information and a wake up interval.

Embodiments of the disclosure provide a terminal device, including: a transceiver. The transceiver is configured to: receive first information, wherein the first information is a low power wake up signal; and monitor a paging message in a paging window, wherein a first start moment of the paging window is determined based on a receiving moment of the first information and a wake up interval.

Embodiments of the disclosure provide network device, including: a transceiver. The transceiver is configured to: send first information, wherein the first information is a low power wake up signal; and send a paging message in a paging window, wherein a second start moment of the paging window is determined based on a sending moment of the first information and a wake up interval.

### BRIEF DESCRIPTION OF THE DRAWINGS

FIG. 1 illustrates a schematic diagram of an application scenario according to embodiments of the disclosure.

FIG. 2 illustrates a first schematic flowchart of a method for paging according to an embodiment of the disclosure.

FIG. 3 illustrates a second schematic flowchart of a method for paging according to an embodiment of the disclosure.

FIG. 4 illustrates a third schematic flowchart of a method for paging according to another embodiment of the disclosure.

FIG. 5 illustrates a schematic diagram of a scenario of a method for paging according to another embodiment of the disclosure.

FIG. 6 illustrates a fourth schematic flowchart of a method for paging according to another embodiment of the disclosure.

FIG. 7 illustrates a second schematic diagram of a scenario of a method for paging according to an embodiment of the disclosure.

FIG. 8 illustrates a schematic block diagram of a terminal device according to an embodiment of the disclosure.

FIG. 9 illustrates a schematic block diagram of a terminal device according to another embodiment of the disclosure.

FIG. 10 illustrates a schematic block diagram of a network device according to an embodiment of the disclosure.

FIG. 11 illustrates a schematic block diagram of a network device according to another embodiment of the disclosure.

FIG. 12 illustrates a schematic block diagram of a communication device according to an embodiment of the disclosure.

FIG. 13 illustrates a schematic block diagram of a chip according to embodiments of the disclosure.

FIG. 14 illustrates a schematic block diagram of a communication system according to embodiments of the disclosure.

### DETAILED DESCRIPTION

Technical solutions of the embodiments of the disclosure will be described below in conjunction with the drawings of the embodiments of the disclosure.

The technical solutions of the embodiments of the disclosure may be applied to various communication systems, such as a Global System of Mobile communication (GSM) system, a Code Division Multiple Access (CDMA) system, a Wideband Code Division Multiple Access (WCDMA) system, a General Packet Radio Service (GPRS) system, a Long Term Evolution (LTE) system, an Advanced Long Term Evolution (LTE-A) system, a New Radio (RA) system, an evolved NR system, an LTE-based access to unlicensed spectrum (LTE-U) system, an NR-based access to unlicensed spectrum (NR-U) system, a Non-Terrestrial Networks (NTN) system, a Universal Mobile Telecommunication System (UMTS), a Wireless Local Area Networks (WLAN), a Wireless Fidelity (WiFi), a 5th-Generation (5G) system or other communication systems.

Generally, a traditional communication system supports a limited number of connections, and is easily achievable. However, with development of communication technologies, a mobile communication system will support not only traditional communication, but will also support for example Device to Device (D2D) communication, Machine to Machine (M2M) communication, Machine Type Communication (MTC), Vehicle to Vehicle (V2V) communication, Vehicle to everything (V2X) communication or the like. The embodiments of the disclosure may also be applied to these communication systems.

In a possible implementation, the communication system of the embodiments of the disclosure may be applied to a carrier aggregation (CA) scenario, or may be applied to a dual connectivity (DC) scenario, or may be applied to a standalone (SA) networking scenario.

In a possible implementation, the communication system of the embodiments of the disclosure may be applied to an unlicensed spectrum. The unlicensed spectrum may be considered as a shared spectrum. Alternatively, the communication system of the embodiments of the disclosure may be applied to a licensed spectrum. The licensed spectrum may be considered as a non-shared spectrum.

In the embodiments of the disclosure, various embodiments are described in conjunction with a network device and a terminal. For example, the terminal device 110 may also be referred to as user equipment (UE), an access terminal, a subscriber unit, a subscriber station, a mobile station, a remote station, a remote terminal, a mobile device, a user terminal, a terminal, a wireless communication device, a subscriber agent or a user device.

The terminal device may be a station (ST) in a WLAN, or may be a cellular phone, a cordless phone, a session initiation protocol (SIP) phone, a wireless local loop (WLL) station, a personal digital assistant (PDA) device, a hand-held device with a wireless communication function, a computing device or another processing device connected to a radio modem, vehicle-mounted device, a wearable device, a terminal device in a next generation communication system for example an NR network, a terminal device in Public Land Mobile Network (PLMN) or the like.

In embodiments of the disclosure, the terminal device may be deployed on the land, including being indoor or outdoor, hand-held, wearable or vehicle-mounted; or the terminal device may be deployed on the water, for example on a chip; or may be deployed in the air, for example on a plane, a balloon, a satellite, or the like.

In embodiments of the disclosure, the terminal device may be a mobile phone, a pad, a computer with a radio transceiving function, a virtual reality (VR) terminal device, an Augmented Reality (AR) terminal device, a radio terminal device used in industrial control, a radio terminal device used in self driving, a radio terminal device used in remote medical, a radio terminal device used in smart grid, a radio terminal device used in transportation safety, a radio terminal device used in smart city, a radio terminal device used in smart home, or the like.

As an example, but not in a limiting way, in embodiments of the disclosure, the terminal device may also be a wearable device. The wearable device may also be referred to as a wearable smart device, and is a generic name of devices that are designed and developed based on daily wear using wearable technologies, for example glasses, gloves, watches, clothes, and shoes. A wearable device is a portable device that is directly worn on a body or integrated into the clothes or accessories of a user. A wearable device is not only a hardware device, but also realizes strong functions through support of software and through data interaction and cloud interaction. Generic wearable smart devices include devices that have plentiful functions and large sizes and can realize all or some functions without depending on a smart phone, for example a smart watch or smart glasses, and also include devices that focus on only some type of application functions and need to be used in cooperation with other devices such a smart phone, for example various smart bracelet and smart jewelries performing sign monitoring.

In embodiments of the disclosure, the network device may be a device for communication with a mobile device. The network device may be an access point (AP) in a WLAN, or a base transceiver station (BTS) in GSM or CDMA, or a NodeB (NB) in WCDMA, or an Evolutional NodeB (eNB or eNodeB) in LTE, or a relay node or access point, or a vehicle-mounted device, a wearable device and a gNB in an NR network, a network device in a future evolved PLAN network, or a network in an NTN network.

As an example, but not in a limiting way, in embodiments of the disclosure, the network device may have mobility. For example, the network device may be a mobile device. Optionally, the network device may be a satellite, or a balloon station. For example, the satellite may be a low earth orbit (LEO) satellite, a medium earth orbit (MEO) satellite, a geostationary earth orbit (GEO) satellite, or a high elliptical orbit (HEO) satellite. Optionally, the network device may also be a base station deployed on the land, in a water area, or the like.

In the embodiments of the disclosure, the network device may provide service for a cell, and a terminal device may communicate with the network device through a transmission resource (for example, a frequency domain resource, or a frequency spectrum resource) used by the cell. The cell may be a cell corresponding to the network device (for example, a base station). The cell may belong to a macro base station, or may belong to a base station corresponding to a small cell. The small cell here may include such as a Metro cell, a Micro cell, a Pico cell, or a Femto cell; and these small cells have the characteristics of having a small coverage and a low transmitting power, and may be applicable for providing high-rate data transmission services.

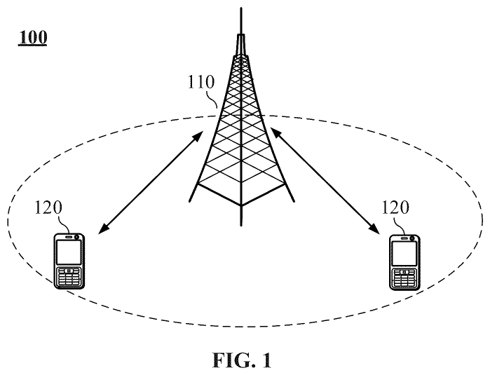

FIG. 1 exemplarily illustrates a communication system 100. The communication system includes a network device 110 and two terminal devices 120. In a possible implementation, the communication system 100 may include multiple network devices 110, and there may be another number of terminal devices 120 within the coverage of each network device 110, which is not limited in the embodiments of the disclosure.

In a possible implementation, the communication system 100 may further include a mobility management entity (MME), an access and mobility management function (AFM) and other network entities, which is not limited in the embodiments of the disclosure.

The network device may further include an access network device and a core network device. That is to say, the wireless communication system may further include multiple core networks for communication with the access network device. The access network device may be an evolutional node B (referred to as eNB or e-NodeB for short), a macro node B, a micro node B (also referred to as small node B), a pico node B, an access point (AP), a transmission point (TP), or a new-generation NodeB (gNodeB) in a long-term evolution (LTE) system, a next generation (mobile communication system)/new radio (NR) system or an authorized auxiliary access long-term evolution (LAA-LTE) system.

It is to be understood that devices having a communication function in the network/system in the embodiments of the disclosure may be referred to as a communication device. With the communication system illustrated in FIG. 1 as an example, the communication device may include a network device and terminal devices that have a communication function. The network device and the terminal devices may be particular devices in the embodiments of the disclosure, which will not be described herein again. The communication device may further include other devices in the communication system, for example a network controller, a mobility management entity and other network entities, which is not limited in the embodiments of the disclosure.

It is to be understood that the terms “system” and “network” herein are often used exchangeably. The term “and/or” herein merely describes a relation between associated objects, representing that three relations may exist. For example A and/or B may represent following three cases: existence of A alone, existence of both A and B, and existence of B alone. The character “/” generally indicates that the contextual objects are in an “or” relationship.

It is to be understood that “indicate” referred to in the embodiments of the disclosure may be direct indication or indirect indication, or may refer to that there is an association relationship. By way of example, “A indicates B” may refer to that A directly indicates B, for example B can be acquired through A. “A indicates B” may also refer to that A indirectly indicates B, for example, A indicates C and B can be acquired through C. “A indicates B” may also refer to that there is an association relationship between A and B.

In the description of the embodiments of the disclosure, the term “correspond” may mean that there is a direct correspondence or indirect correspondence between two objects, or may mean that there is an association relationship between the two object, or may mean a relationship that one object indicates or is indicated by another object or a relationship that one object configures or is configured by another object.

For convenience in understanding the technical solutions of the embodiments of the disclosure, the relevant technologies of the embodiments of the disclosure are described hereinafter. Any combination formed by the relevant technologies below as optional solutions and the technical solutions of the embodiments of the disclosure shall fall within the scope of protection of the embodiments of the disclosure.

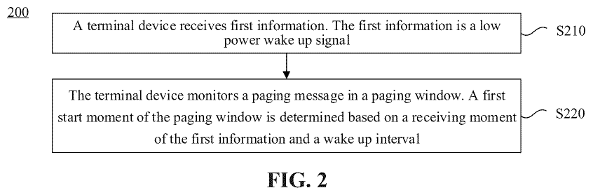

FIG. 2 illustrates a schematic flowchart of a method 200 for paging according to an embodiment of the disclosure. The method may optionally be applied to the system of FIG. 1, but the disclosure is not limited thereto. The method may include at least part of the following content.

S210, a terminal device receives first information. The first information is a low power wake up signal.

S220, the terminal device monitors a paging message in a paging window. A first start moment of the paging window is determined based on a receiving moment of the first information and a wake up interval.

In the embodiment, before the action S210 that the terminal device receives the first information, the method may further include that the terminal device continuously monitors the first information in a case that the terminal device is in a first state. That is to say, before the terminal device performs the S210, the terminal device is in the first state, and the terminal device continuously monitors the first information in the first state, until the terminal device receives the first information, namely performing S210. In S210, the event that the terminal device receives the first information may particularly mean that the first information is monitored by the terminal device.

Correspondingly, after S210 is completed and before S220 is performed, the method may further include that the terminal device switches from the first state to a second state in a case that the terminal device receives the first information. Power consumption of the terminal device in the first state is lower than power consumption of the terminal device in the second state. That is to say, in the case that the terminal device receives the first information, the terminal device may switch its state from the first state to the second state.

The first information may be information for instructing the terminal device to prepare to monitor a paging message. The first information may particularly be a low power wake up signal (LP-WUS), or an ultra-low power wake up signal, or an almost zero power (AZP) wake up signal. It is to be understood that the first information may also be other signals, which, for example, may be referred to as a wake up signal, a wake up indication signal or the like. Any information for instructing the terminal device to prepare to monitor a paging message falls within the scope of protection of the embodiment, examples of which are not provided in an exhaustive way in the embodiment.

The first state may refer to that the terminal device is in a state where it does not use a master receiver, or that the terminal device is in a state where it only uses a low consumption receiver or an ultra-low consumption receiver and does not use the master receiver. The second state may be a state in which the terminal device starts or wakes up the master receiver, or a state in which the terminal device starts or wakes up the master receiver to prepare to monitor a paging message.

The master receiver of the terminal device may be a receiver capable of monitoring a paging message. The low consumption receiver used by the terminal device may be a receiver receiving only a specific signal, for example the low consumption receiver may receive only the first information mentioned before, and of course may also receive other information or signals, examples of which are not provided in an exhaustive way in the embodiment.

After receiving the first information, the terminal device may further determine the first start moment of the paging window. The first start moment of the paging window is determined according to a receiving moment of the first information and a wake up interval. In particular, after the terminal device receives the first information, the method may further include that the terminal device determines a moment that is later than the receiving moment of the first information by the wake up interval as the first start moment of the paging window. For example, the receiving moment of the first information is denoted as t1, the wake up interval is denoted as T1, and the first start moment of the paging window is denoted as t2. Then, t2=t1+T.

The above wake up interval may also be denoted as warm-up time. Of course, the wake up interval may also be denoted as other names, for example a waiting interval, a preparation interval, a wake-up waiting interval, a wake-up preparation interval, or a wake-up preparation period, examples of which are not provided in an exhaustive way in the embodiment.

In particular, the wake up interval may be a default wake up interval, or a wake up interval of the terminal device.

The default wake up interval may be configured for the terminal device by a network device, or may be preset.

The way in which the network device configures the default wake up interval for the terminal device may include: the terminal device receives configuration information from the network device, and the configuration information contains the default wake up interval. The configuration information may be carried by at least one of following: a system message, a radio resource control (RRC) signaling, or downlink control information (DCI).

The default wake up interval may be used in the following way: in a case that the network device fails to acquire a wake up interval of the terminal device, the network device uses the default wake up interval to determine the first start moment of the paging window corresponding to the terminal device; correspondingly, in a case that the wake up interval of the terminal device is not stored on the network device side, the network device may configure a default wake up interval for the terminal device in advance, so that the first start moment of the paging window determined by the terminal device is the same as or is substantially the same as a second start moment of the paging window determined by the network device. Since the terminal device and the network device determines the start moment of the paging window independently, the first start moment of the paging window may be the same as or may be different from the second start moment of the paging window.

For another example, the default wake up interval may be preset in the network device and the terminal device, as long as the default wake up interval stored in the network device is the same as that stored in the terminal device.

The wake up interval of the terminal device may be a duration in which the terminal device switches from a first state to a second state, and power consumption of the terminal device in the first state is lower than power consumption of the terminal device in the second state. The wake up interval of the terminal device may particularly be the time it takes for the terminal device to wake up its master receiver to start to prepare for monitoring the paging message since receiving the first information. The wake up interval of the terminal device may include the total duration it takes for the terminal device to perform at least one of the following operations: start up of the master receiver, stabilization of a crystal oscillator, rough synchronization, fine synchronization and so on. It is to be understood that the above operations performed by the terminal device are merely for exemplary description. It does not mean that only the above operations can be performed, and other operations may also be performed, examples of which are not provided in an exhaustive way in the embodiment.

The wake up interval of the terminal device is information that the terminal device can obtain by itself. The wake up interval of the terminal device may be reported to the network device by the terminal device actively. For example, when the terminal device accesses a system for the first time, the terminal device reports the wake up interval of the terminal device as one of capabilities of the terminal device to a corresponding network device; and then the network device may send the wake up interval of the terminal device to a core network device and store it. In turn, when any network device needs to send first information to the terminal device and to further send a corresponding paging message to the terminal device, it may receive the wake up interval of the terminal device from the core network device.

Alternatively, the wake up interval of the terminal device may be reported by the terminal device as instructed by the network device. For example, in a case that the terminal device is connected to a network device, the network device queries that the wake up interval of the terminal device is not stored at a core network (or in the network device locally). In this case, the network device may send to the terminal device information instructing the terminal device to report the wake up interval thereof, and then the terminal device reports the wake up interval of the terminal device to the network device. The network device may send the wake up interval of the terminal device to a core network device and store it. In turn, when any network device needs to send first information to the terminal device and to further send a corresponding paging message to the terminal device, the wake up interval of the terminal device may be received from the core network device. In such a case, since the wake up interval of the terminal device is stored at the network device side, both the network device and the terminal device may use the wake up interval of the terminal device to determine the first start moment of the paging window, so that the first start moment of the paging window determined by the terminal device is substantially the same as the second start moment of the paging window determined by the network device.

It is also to be noted that, the default wake up interval is usually greater than the wake up interval of any terminal device. That is because under the situation that without knowing the wake up interval of a terminal device, the network device estimates the first start moment of the paging window corresponding to the terminal device in a conservative way (namely using a longer default wake up interval), so as to prevent the terminal device from missing detection of the paging message.

After determining the first start moment of the paging window, the terminal device may perform the above-mentioned S220 that the terminal device monitors the paging message in the paging window. In particular, S220 may include: the terminal device monitors the paging message on at least one paging occasion (PO) in the paging window starting from the first start moment of the paging window.

That is to say, under the situation that the terminal device determines the first start moment of the paging window and switches from the first state to the second state, the terminal device monitors the paging message on one or more POs starting from the first start moment of the paging window.

The way in which the terminal device determines to stop monitoring the paging message may include that: the terminal device stops monitoring the paging message on the at least one PO in the paging window, in a case that a first condition is satisfied.

The particular content of the first condition may differ as relevant information preconfigured for the terminal device change. For example, a total duration of the paging window may be preconfigured for the terminal device, or a total amount of time-domain resources may be preconfigured for the terminal device. The two approaches are described hereinafter.

Approach I: a total duration of the paging window is preconfigured for the terminal device. In this approach, the first condition may include at least one of following: a monitoring duration in which the terminal device monitors the paging message on the at least one PO exceeds a total duration of the paging window; or a paging message containing an identifier of the terminal device is received by the terminal device on a first PO. The first PO is one of the at least one PO.

The total duration of the paging window is configured by a network device. Alternatively, the total duration of the paging window may also be a preset default total duration of the paging window. For example, the default total duration of the paging window may be directly written into the terminal device, and the same default total duration of the paging window may be preset for the terminal device and the network device. It is to be noted that, the default total duration of the paging window may be longer than the total duration of the paging window configured by the network device. That is because the network device expects the terminal device to be able to receive the paging message corresponding thereto. Therefore, a longer default total duration of the paging window may be set for the network device and the terminal device, to ensure that the terminal device can receive the paging message.

The operation that the terminal device determines whether to stop monitoring the paging message based on the above condition that the monitoring duration in which the terminal device monitors the paging message on the at least one PO exceeds the total duration of the paging window may particularly include that: the terminal device monitors the paging message on the at least one PO starting from the first start moment of the paging window and records the current monitoring duration, and stops monitoring the paging message when the monitoring duration exceeds the total duration of the paging window and no paging message containing the identifier of the terminal device is received d by the terminal device. In such a situation, because no paging message containing the identifier of the terminal device is received by the terminal device this time, the terminal device may return to the first state again from the current second state, to still continuously monitor the first information in the first state. Then, S210 and S220 may be performed by the terminal device again.

The operation that the terminal device determines whether to stop monitoring the paging message based on the above condition that the paging message containing the identifier of the terminal device is received by the terminal device on the first PO may particularly include that: the terminal device monitors the paging message on the at least one PO starting from the first start moment of the paging window and records a monitoring duration, and stops monitoring the paging message when the monitoring duration does not exceed the total duration of the paging window and the paging message containing the identifier of the terminal device is received by the terminal device on the first PO. The first PO is any one of the at least one PO. Further, the terminal device may respond to the network device about the paging. For example, the paging message of the terminal device itself is received by the terminal device in an RRC state, and then the terminal device may send a paging response to the network device. The paging response may be carried in an RRC connection request.

Further, the PO may be a PO of the terminal device, or may be an available PO of a cell. The first condition in the approach I is described in two cases.

### First Case of Approach I

The PO may be a PO of the terminal device. In this case, at least one more POs are at least one PO of the terminal device or multiple POs of the terminal device. Correspondingly, the first PO may be a first PO of the terminal device.

The first condition may particularly be one of following: a monitoring duration in which the terminal device monitors the paging message on the at least one PO of the terminal device exceeds a total duration of the paging window; or a paging message containing an identifier of the terminal device is received by the terminal device on a first PO of the terminal device. The first PO of the terminal device is one of the at least one PO of the terminal device.

The operation that the terminal device determines whether to stop monitoring the paging message based on the condition that the monitoring duration in which the terminal device monitors the paging message on the at least one PO of the terminal device exceeds the total duration of the paging window may particularly include that: the terminal device monitors the paging message on the at least one PO of the terminal device starting from the first start moment of the paging window and records a current monitoring duration, and stops monitoring the paging message when the monitoring duration exceeds the total duration of the paging window and no paging message containing the identifier of the terminal device is received by the terminal device.

The operation that the terminal device determines whether to stop monitoring the paging message based on the condition that the paging message containing the identifier of the terminal device is received by the terminal device on the first PO of the terminal device may particularly include that: the terminal device monitors the paging message on the at least one PO of the terminal device starting from the first start moment of the paging window and records the current monitoring duration, and stops monitoring the paging message when the monitoring duration does not exceed the total duration of the paging window and the paging message containing the identifier of the terminal device is received by the terminal device on the first PO of the terminal device. The first PO of the terminal device is one of the at least one PO of the terminal device.

Further, description about the at least one PO of the terminal device and the way of determining same is as follows.

The main function of paging is to enable a network device to page for a terminal device in a radio resource control idle (RRC-IDLE) state or an RRC inactive (RRC-INACTIVE) state, or to inform the terminal device of a system message change or earthquake and tsunami/public early warning information via a short message (applicable for all RRC states of UE, including the connected state). The paging message is transmitted or carried by a physical downlink shared channel (PDSCH) scheduled by physical downlink control channel (PDCCH) that is scrambled by a paging radio network temporary identity (P-RNTI). The short message includes 8 bits and is carried in the PDCCH.

For the terminal device in an RRC idle state or an RRC inactive state, a paging channel may be monitored in a discontinuous reception (DRX) way, namely using a paging DRX mechanism, in order to reduce power consumption of the terminal device. Under the paging DRX mechanism, the terminal device only monitors the paging message during one PO in each DRX period.

Each DRX period may include multiple POs, and each of the multiple POs may be an available PO of a cell. The available PO of the cell may refer to an available PO of the cell where the terminal device is currently located. Each of the multiple PO is one or more physical downlink control channels (PDCCHs) monitoring occasions, and may be composed of multiple slots. In addition, there is also a concept of paging frame (PF). A PF refers to a radio frame (with a length of 10 ms). The PF may include multiple POs or start positions (or start moments) of multiple POs. In order to further reduce the power consumption of the terminal device.

For a terminal device, there may be at most a value of one PF and a value of a PO corresponding to the PF in a paging DRX period. That is to say, for the terminal device, there may be at most a PO of the terminal device (or referred to as a PO of the terminal device itself) on one PF in a paging DRX period.

The paging DRX period is decided by a common period in system broadcast and a dedicated period configured in a high-layer signaling (NAS signaling) together, of which a smaller one is determined by the terminal device as the paging period. The position of the PO of the terminal device itself where the terminal device performs monitoring is related to an identifier of the terminal device (for example, ID of the terminal device). In particular, the PF of a terminal device in a paging DRX period and the identifier of the PO of the terminal device itself are determined in the following way:
the value of the PF is determined by the following formula: (SFN+PF_offset) mod T=(T div N)(UE_ID mod N); and
the value of the identifier of the PO of the terminal device itself (or the identifier of the PO of the terminal device) is determined by the following formula: i_s=Floor(UE_ID/N)mod Ns.

T is the paging DRX period of the terminal device receiving the paging message. The network device broadcasts a default paging DRX period. If a dedicated paging DRX period is configured for the terminal device by an RRC/high layer, then a smaller one of the paging DRX period broadcast by the network device and the paging DRX period specific to the terminal device and configured by the RRC/high layer is taken as the paging DRX period of the terminal device. If no dedicated paging DRX period is configured for the terminal device by the RRC/high layer, then the paging DRX period broadcast by the network device is taken as the paging DRX period of the terminal device.

N is the number of PFs contained in a paging DRX period.

Ns is the number of POs contained in a PF.

PF_offset is used for determining a time-domain offset amount of the PF.

i_s is the identifier of the PO of the terminal device itself (or the identifier of the PO of the terminal device).

UE_ID is the identifier of the terminal device, and is 5G-S-TMSI mod 1024.

T may be indicated by “defaultPagingCycle” field in configuration of the system message.

Ns may be indicated by “ns ENUMERATED{four,two,one}” in the configuration of the system message.

PF_offset may be indicated by “nAndPagingFrameOffset” field in the configuration of the system message. For example, the field may include:

| nAndPagingFrameOffset | CHOICE{ |
|---|---|
| ...... | |
| halfT | INTEGER (0..1), |

......};

Herein, “halfT INTEGER (0 . . . 1)” indicates that in the case that n is T/2, the value of PF_offset is an integer and ranges from 0 to 1.

The PO of the terminal device may be composed of multiple PDCCH monitoring occasions. For example, a PO of the terminal device may include X PDCCH monitoring occasions. X is a positive integer, and X is equal to the number of actually transmitted synchronization signal and PBCH blocks (SSBs), which are broadcast in a master information block (MIB).

The terminal device may determine the position of a PF in a paging DRX period and the identifiers (or indexes) of POs of the terminal device according to the above formulas. After the terminal device determines the PF, the identifiers (or indexes) of the POs of the terminal device, and the number X of PDCCH monitoring occasions in a PO of the terminal device, the terminal device can determine a particular position of each PO of the terminal device in the time domain by only determining a start position of the first PDCCH monitoring occasion of each PO of the terminal device and further in combination with the duration of one PO. The start position of the PDCCH monitoring occasion may be configured by a high-layer signaling, or may be obtained based on the identifiers (or indexes) of the POs of the terminal device. The duration of one PO is the cycle of beam scanning (which may be configured by the system).

The way in which the terminal device determines the start position of the first PDCCH monitoring occasion of each PO of the terminal device may be that the start position may be determined by a configuration in a system message, for example, the start position may be determined by a “firstPDCCH-MonitoringOccasionOfPO” field. For example, the terminal device obtains the start position of the first PDCCH monitoring occasion in each of available POs of the cell where the terminal device is located according to the above field, and then according to the identifier of the PO of the terminal device itself, the terminal device may determine the start position of the first PDCCH monitoring occasion of the PO of the terminal device itself.

Exemplarily, the way in which the terminal device obtains the start position of the first PDCCH monitoring occasion in each of the available POs of the cell where the terminal device is located according to the above field is described as follows.

The “firstPDCCH-MonitoringOccasionOfPO” part may contain the following content:

```
  firstPDCCH-MonitoringOccasionOfPO CHOICE{
sCS15KHZoneT SEQUENCE(SIZE(1..maxPO-perPF))OF INTEGER
(0..139),
  ......}
```

In the field, “sCS15KHZoneT” indicates a case of a 15 KHz subcarrier interval, “SEQUENCE (SIZE (1 . . . maxPO-perPF)” indicates the number of POs in a PF in the case of the 15 KHz subcarrier interval. “maxPO-perPF” is used for indicating the maximum number of POs in a PF configured by the system. It is assumed that maxPO-perPF is 16 (or may be 32), “SEQUENCE (SIZE (1 . . . maxPO-perPF)” may indicate 12. That is to say, there are 12 integer values in “INTEGER (0 . . . 139)”. Here, the 12 integer values may indicate available POs of the cell. The value range of the integer values is indicated by “(0 . . . 139)” and is from 0 to 139. By way of example, INTERGER may contain numeric values such as 0, 8, 15 and 21 to indicate the start position of the first PDCCH monitoring occasion of each of available POs of the cell where the terminal device is located.

After determining the above PF and each of POs of the terminal device, the terminal device may perform blind detection on the paging message according to the determined POs of the terminal device. Exemplarily, the operation that the terminal device monitors the paging message on any PO of the terminal device itself may include that: the terminal device monitors a PDCCH scrambled with P-RNTI on a PO of the terminal device corresponding to the PF; and if the PDCCH scrambled with P-RNTI is detected by the terminal device on its own PO, the terminal device reads each PagingRecord in a PagingRecordList carried in the PDCCH. The PagingRecord contains identifiers of terminal devices (UE-Identity) that are paged. In turn, if the terminal device finds out that its identifier is consistent with an identifier (UE-Identity) of one of the paged terminal devices, it is determined that the paging message containing the identifier of the terminal device itself is received. If the terminal device finds out that the identifier (UE-Identity) of no paged terminal device is consistent with the identifier of the terminal device itself, the terminal device will discard the received paging message.

### Second Case of Approach I

The PO may be an available PO of a cell. The cell may be a cell where the terminal device is located at present, and more particularly may refer to a serving cell corresponding to the terminal device. The available PO of the cell may particularly be an available PO of the serving cell corresponding to the terminal device. The cell may contain one or more available POs, which are referred to as at least one available PO of the cell hereinafter in the embodiments of the disclosure.

The first condition may particularly be one of following: a monitoring duration in which the terminal device monitors the paging message on the at least one available PO of the cell exceeds a total duration of the paging window; or a paging message containing an identifier of the terminal device is received by the terminal device on a first available PO of the cell. The first available PO of the cell is one of the at least one available PO of the cell.

It is to be noted that the first available PO of the cell does not mean the first available PO of the cell, but means any of the at least one available PO of the cell where the paging message of the terminal device is received by the terminal device itself. More particularly, the first available PO of the cell means any of the at least one available PO of the cell where the paging message containing the identifier of the terminal device is received by the terminal device itself.

Further, the operation that the terminal device determines whether to stop monitoring the paging message based on the condition that the monitoring duration in which the terminal device monitors the paging message on the at least one PO of the terminal device exceeds the total duration of the paging window may particularly include that: the terminal device monitors the paging message on the at least one available PO of the cell starting from the first start moment of the paging window and records a monitoring duration, and stops monitoring the paging message when the monitoring duration exceeds the total duration of the paging window and no paging message containing the identifier of the terminal device is received by the terminal device.

The operation that the terminal device determines whether to stop monitoring the paging message based on the condition that the paging message containing the identifier of the terminal device is received by the terminal device on the first available PO of the cell may particularly include that: the terminal device monitors the paging message on the at least one available PO of the cell starting from the first start moment of the paging window and records a monitoring duration, and stops monitoring the paging message when the monitoring duration does not exceed the total duration of the paging window and the paging message containing the identifier of the terminal device is received by the terminal device on the first available PO of the cell. The first available PO of the cell is one of the at least one available PO of the cell.

Regarding the second case of approach I, it is to be noted that, in the present case, the terminal device may monitor the paging message on all available POs of the cell after the first start moment of the paging window, which differs from the above first case of approach I in that the terminal device only monitors the paging message on its PO in the first case.

Description about the available POs of the cell and the way of determining same is as follows.

For the terminal device in an idle state, a paging message may be monitored in a discontinuous reception (DRX) way, in order to reduce power consumption of the terminal device. In a DRX period, the terminal device monitors whether there is a paging radio network temporary identity (P-RNTI) on a physical downlink control channel (PDCCH) only on POs on a corresponding PF, so as to determine whether a corresponding physical downlink shared channel (PDSCH) bears a paging message. The PF corresponds to a radio frame, and the PF may contain multiple POs or start positions (start moments) of the multiple POs.

In the present case, the terminal device may monitor the paging message on all available POs of the cell after the first start moment of the paging window.

After the terminal device determines the PF, and the number X of PDCCH monitoring occasions in each available PO of the cell, the terminal device can determine a particular position of each available PO of the cell in the time domain in combination with the duration of one available PO of the cell and by determining a start position of the first PDCCH monitoring occasion of each available PO of the cell via relevant configuration parameters. The start position of the PDCCH monitoring occasion may be configured by a high-layer signaling, or may be obtained based on the identifiers (or indexes) of the POs of the terminal device. The duration of one PO is the cycle of beam scanning.

The way in which the terminal device determines the available POs of the cell and the start position of the first PDCCH monitoring occasion of each available PO of the cell may be implemented through determination according to a configuration in a system message.

For example, the start position of the first PDCCH monitoring occasion of each available PO of the cell may be determined by a “firstPDCCH-MonitoringOccasionOfPO” field. Exemplarily, the “firstPDCCH-MonitoringOccasionOfPO” part may contain the following content:

```
  firstPDCCH-MonitoringOccasionOfPO CHOICE{
sCS15KHZoneT SEQUENCE(SIZE(1..maxPO-perPF))OF INTEGER
(0..139),
  .......}
```

In the field, “sCS15KHZoneT” indicates a case of a 15 KHz subcarrier interval, “SEQUENCE (SIZE (1 . . . maxPO-perPF)” indicates the number of POs in a PF in the case of the 15 KHz subcarrier interval. “maxPO-perPF” is used for indicating the maximum number of POs in a PF configured by the system. Assuming that maxPO-perPF is 16 (or may be 32), “SEQUENCE (SIZE (1 . . . maxPO-perPF)” may indicate 4. That is to say, there are 4 integer values in “INTEGER (0 . . . 139)”. Here, the 4 integer values may indicate 4 available POs of the cell. The value range of the integer values is indicated by “(0 . . . 139)” and is from 0 to 139. By way of example, INTERGER may contain 0, 8, 15 and 21 to indicate the start position of the first PDCCH monitoring occasion of each available PO of the cell where the terminal device is located.

Exemplarily, the operation that the terminal device monitors the paging message on the available POs of the cell may include that: the terminal device monitors a PDCCH scrambled with RNTI on each of the available POs of the cell corresponding to the PF; and if the PDCCH scrambled with the RNTI is detected by the terminal device on any of the available POs of the cell, the terminal device reads each PagingRecord in a PagingRecordList carried in the PDCCH. The PagingRecord contains identifiers of terminal devices (UE-Identity) that are paged. If the terminal device finds out that its identifier is consistent with an identifier (UE-Identity) of one of the paged terminal devices, it is determined that the paging message containing the identifier of the terminal device itself is received. If the terminal device finds out that the identifier (UE-Identity) of no paged terminal device is consistent with the identifier of the terminal device itself, the terminal device will discard the received paging message.

Approach II: the terminal device is preconfigured with a total number of time-domain resources.

The first condition includes at least one of following: a number of POs on which the terminal device has performed monitoring exceeds a total number of time-domain resources; or a paging message containing an identifier of the terminal device is received by the terminal device on a second PO. The second PO is one of the at least one PO.

The total number of the time-domain resources is configured by a network device.

Alternatively, the total number of the time-domain resources may also be a preset default total number of the time-domain resources. For example, the preset default total number of the time-domain resources may be directly written into the terminal device and the network device, and the same default total number of the time-domain resources may be used by the terminal device and the network device. It is to be noted that, the default total number of the time-domain resources may be larger than the total number of the time-domain resources configured by the network device. That is because the network device expects the terminal device to be able to receive the paging message corresponding thereto. Therefore, a larger default total number of the time-domain resources may be set for the network device and the terminal device, to ensure that the terminal device can receive the paging message.

The operation that the terminal device determines whether to stop monitoring the paging message based on the above condition that the number of the POs on which the terminal device has performed monitoring exceeds the total number of time-domain resources may particularly include that: the terminal device monitors the paging message on at least one PO starting from the first start moment of the paging window and records the number of POs on which monitoring has been performed, and stops monitoring the paging message when the number of POs on which monitoring has been performed exceeds the total number of the time-domain resources and still no paging message containing the identifier of the terminal device is received d by the terminal device. In such a situation, because no paging message containing the identifier of the terminal device is received by the terminal device this time, the terminal device may return to the first state again from the current second state, to continuously monitor the first information. Then, S210 and S220 may be performed by the terminal device again.

The operation that the terminal device determines whether to stop monitoring the paging message based on the above condition that the paging message containing the identifier of the terminal device is received by the terminal device on the second PO may particularly include that: the terminal device performs monitoring on POs starting from the first start moment of the paging window and records the number of POs on which monitoring has been performed, and stops monitoring the paging message when the number of POs on which monitoring has been performed does not exceed the total number of the time-domain resources and a paging message containing the identifier of the terminal device is received on the second PO. The second PO may be any one of the at least one PO. That is to say, the monitoring may be stopped as long as the paging message containing the identifier of the terminal device is received by the terminal device on any of the time-domain resources. The terminal device may further send a paging response to the network device. For example, the paging message of the terminal device itself is received by the terminal device in an RRC state, and then the terminal device may send a paging response to the network device. The paging response may be carried in an RRC connection request.

Much further, the PO may be a PO of the terminal device, or may be an available PO of a cell. The first condition in the approach II is described in two cases.

### First Case of Approach II

The PO may be a PO of the terminal device. In this case, at least one or more POs are at least one PO of the terminal device or multiple POs of the terminal device. The second PO may be a second PO of the terminal device.

The first condition may particularly be at least one of following: a number of POs of the terminal device on which the terminal device has performed monitoring exceeds a total number of time-domain resources; or a paging message containing an identifier of the terminal device is received by the terminal device on a second PO of the terminal device. The second PO of the terminal device is one of the at least one PO of the terminal device.

It is to be understood that the second PO of the terminal device does not mean the second PO of all POs of the terminal device, but mean that the PO on which the paging message containing the identifier of the terminal device is received by the terminal device is any one of the at least one PO of the terminal device.

The operation of determining whether to stop monitoring the paging message based on the condition that the number of POs of the terminal device on which the terminal device has performed monitoring exceeds the total number of the time-domain resources may particularly include that: the terminal device performs monitoring on POs of the terminal device after the first start moment of the paging window and records the number of POs on which monitoring has been performed, and stops monitoring the paging message if the number of POs on which monitoring has been performed exceeds the total number of the time-domain resources and no paging message containing the identifier of the terminal device is received by the terminal device.

The operation of determining whether to stop monitoring the paging message based on the condition that the paging message containing the identifier of the terminal device is received by the terminal device on the second PO of the terminal device may particularly be that: the terminal device performs monitoring on POs of the terminal device starting from the first start moment of the paging window and records the number of POs on which monitoring has been performed, and stops monitoring the paging message if the number of POs on which monitoring has been performed does not exceed the total number of the time-domain resources and the paging message containing the identifier of the terminal device is received by the terminal device on any PO of the terminal device.

Description of the POs of the terminal device and the way of determining same is the same as that in the approach I, which will not be described here again.

### Second Case of Approach II

The at least one PO may be an available PO of a cell. The cell may be a cell where the terminal device is located at present, and more particularly may refer to a serving cell corresponding to the terminal device. The available PO of the cell may particularly be an available PO of the serving cell corresponding to the terminal device. The cell may contain one or more available POs, which are referred to as at least one available PO of the cell hereinafter in the embodiments of the disclosure. The second PO may be a second available PO of a cell.

That is to say, the first condition may particularly be one of following: a number of available POs of the cell on which the terminal device has performed monitoring exceeds the total number of the time-domain resources; or a paging message containing an identifier of the terminal device is received by the terminal device on a second available PO of the cell. The second available PO of the cell is one of the at least one available PO of the cell.

It is to be noted that the second available PO of the cell does not mean the second available PO of the cell, but means any of the at least one available PO of the cell where the paging message of the terminal device is received by the terminal device itself.

Further, the operation that the terminal device determines whether to stop monitoring based on the condition that the number of available POs of the cell on which the terminal device has performed monitoring exceeds the total number of time-domain resources may particularly include that: the terminal device monitors the paging message on available POs of the cell starting from the first start moment of the paging window and records the number of available POs on which monitoring has been performed, and stops monitoring the paging message if the number of available POs on which monitoring has been performed exceeds the total number of the time-domain resources and no paging message containing the identifier of the terminal device is received by the terminal device. That is to say, no paging message containing the identifier of the terminal device is received by the terminal device on any of the available POs of the cell. When such a condition is satisfied, namely no paging message containing the identifier of the terminal device is received by the terminal device this time, the terminal device may further return to the first state again from the current second state, to continuously monitor the first information. Then, S210 and S220 may be performed by the terminal device again.

The operation that the terminal device determines whether to stop monitoring based on the condition that the paging message containing the identifier of the terminal device is received by the terminal device on the second available PO of the cell may particularly include that: the terminal device monitors the paging message on available POs of the cell starting from the first start moment of the paging window and records the number of available POs on which monitoring has been performed, and stops monitoring the paging message if the number of available POs on which monitoring has been performed does not exceed the total number of the time-domain resources and the paging message containing the identifier of the terminal device is received by the terminal device on the second available PO of the cell. The second available PO of the cell is any one of the at least one available PO of the cell.

Description of the available POs of the cell and the way of determining same is the same as that in the approach I, which will not be described here again.

In both the two cases of approach II, the total number of the time-domain resources may be configured by a network device. It is to be noted that, the particular numeric value of the total number of the time-domain resources may be the same or different in the two cases. For example, the particular numeric value of the total number of the time-domain resources in the first case of approach II is N (an integer greater than or equal to 1), and the particular numeric value of the total number of the time-domain resources in the second case of approach II is M (an integer greater than or equal to 1). N may be greater than M, or may be smaller than M, or may be equal to M.

It is also to be understood that when performing the above S210 and S220, the terminal device may be in an RRC-IDLE state or an RRC-INACTIVE state, and the terminal device may enter the RRC-ACTIVE (activated) state after the paging message containing the identifier of the terminal device is received by the terminal device.

The particular operation that the terminal device determines the first start moment of the paging window according to the receiving moment of the first information and the wake up interval in the case of having received the first information, and further monitors the paging message on a PO contained in the paging window has been described in the foregoing embodiments. The relevant operation needing to be performed by the terminal device before performing S210 and S220 is described hereinafter.

The terminal device sends second information. The second information includes low power wake up capability information of the terminal device.

The operation that the terminal device sends the second information may be performed actively when the terminal device accesses the system for the first time or is in an RRC connected state any time. It is to be pointed out that, the network device receiving the second information reported by the terminal device may be the same as or different from the above network device sending the first information, depending on the network device that the terminal device is currently connected to. Correspondingly, the network device also reports low power wake up capability information of the terminal device that is contained in the second information to a core network device.

Alternatively, the operation that the terminal device sends the second information may be performed passively, namely performed as instructed by the network device. For example, the terminal device may send the second information to the network device in the case of receiving a capability information report instruction from the network device. Similarly, the network device also reports the low power wake up capability information of the terminal device that is contained in the second information to the core network device.

Optionally, the second information may further include a wake up interval of the terminal device. That is to say, based on that the terminal device reports the low power wake up capability information of the terminal device to the network device, the terminal device may further report the wake up interval of the terminal device to the network device. The wake up interval of the terminal device has been particularly explained in the above embodiments, and will not be described here again.

Additionally, it has been described above that the total duration of the paging window and the total number of the time-domain resources may be configured by the network device. For example, it may be the case that the terminal device receives fifth information from the network device. The fifth information includes the total duration of the paging window or the total number of the time-domain resources. The receiving of the fifth information may be performed before S210 or may be performed before S220, which will not be limited. The fifth information is carried by at least one of following: a system message, a radio resource control (RRC) dedicated signaling, or downlink control information (DCI).

Through the above solution, in the case of having received first information, a terminal device determines a first start moment of a paging window according to a receiving moment of the first information and a wake up interval, and monitors a paging message in the paging window. In this way, by determining the window for monitoring the paging message according to the receiving moment of the first information in combination with the wake up interval, the terminal device is enabled to determine an appropriate occasion of receiving the paging message, which can prevent the terminal device from missing receipt of the paging message and avoid the delay problem of the paging message caused by the terminal device waiting for too much time to start the monitoring. Therefore, it can be ensured that the terminal device receives the paging message in a timely manner, thus improving the processing efficiency of the entire system.

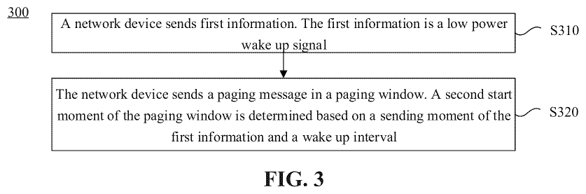

FIG. 3 illustrates a schematic flowchart of a method 300 for paging according to an embodiment of the disclosure. The method may optionally be applied to the system of FIG. 1, but the disclosure is not limited thereto. The method may include at least part of the following content.

In S310, a network device sends first information. The first information is a low power wake up signal.

In S320, the network device sends a paging message in a paging window. A second start moment of the paging window is determined based on a sending moment of the first information and a wake up interval.

In the embodiment, before S310, the method may include that the network device receives fourth information from a core network device. The fourth information includes low power wake up capability information of a terminal device. Further, S310 may particularly be that the network device sends the first information to the terminal device in the case that the network device receives the fourth information from the core network device. The fourth information may be used for triggering the network device to send a paging message to the terminal device.

It is to be understood that the network device may communicate with multiple terminal devices simultaneously. In this embodiment, the terminal device may refer to any one of the multiple terminal devices. The description involved in this embodiment is all about one terminal device, and processing of the others of the multiple terminal devices is similar, which is not described repeatedly.

The fourth information may carry low power wake up capability information of the terminal device. That is to say, the core network device triggers the network device to send the paging message for the terminal device, and the low power wake up capability information of the terminal device may be indicated at the same time. If the low power wake up capability information of the terminal device indicates that the terminal device supports or has the low power wake up capability, then the network device sends the first information to the terminal device. Otherwise, the network device and the terminal device may perform subsequent processing using a normal paging procedure, which will not be described herein.

Further, the fourth information may further contain a wake up interval of the terminal device, or may not contain the wake up interval of the terminal device. Here, it is to be understood that, the network device may communicate with multiple terminal devices simultaneously. That is to say, the network device may obtain the wake up intervals of multiple terminal devices, and the wake up intervals of different terminal devices may be the same or may be different, which is related to the capabilities of the terminal devices. For example, the network device is triggered to initiate paging for 3 terminal devices, and then the network device may obtain the wake up interval of a terminal device 1, the wake up interval of a terminal device 2 and the wake up interval of a terminal device 3.

The first information may be information for instructing the terminal device to prepare to monitor a paging message. For example, the first information may particularly be a low power wake up signal (LP-WUS), or an ultra-low power wake up signal, or an almost zero power (AZP) wake up signal. It is to be understood that the first information may also be other signals, which, for example, may be referred to as a wake up signal, a wake up indication signal or the like. Any information for instructing the terminal device to prepare to monitor a paging message falls within the scope of protection of the embodiment, examples of which are not provided in an exhaustive way in the embodiment. Here, it is to be understood that the network device may communicate with multiple terminal devices simultaneously, and the core network device may carry, in the fourth information, relevant information of the terminal device to be paged this time, for example, an identifier of the terminal device. Correspondingly, at S310, the network device sends the first information to the corresponding terminal device. For example, the fourth information is used for triggering the network device to sending paging to a terminal device 1, and the network device determines that the terminal device 1 supports or has the low power wake up capability, and then the network device sends the first information to the terminal device 1.

After completing S310, the network device may further determine the second start moment of the paging window based on the sending moment of the first information and the wake up interval. That is to say, after the network device sends the first information to the terminal device, the method may further include that the network device determines a moment that is later than the sending moment of the first information by the wake up interval as the second start moment of the paging window. For example, the sending moment of the first information is denoted as t3, the wake up interval is denoted as T, and the second start moment of the paging window is denoted as t4. Then, t4=t3+T. It has been described above that a network device may communicate with multiple terminal devices simultaneously, and the processing in this embodiment is all about the same terminal device. For example, at S310, the network device may send first information to a terminal device 1; and after completing S310, the network device determines the second start moment of the paging window corresponding to the terminal device 1 based on the sending moment of sending the first information to the terminal device 1 and the wake up interval.

The above wake up interval may also be denoted as warm-up time. Of course, the wake up interval may also be denoted as other names, for example a waiting interval, a preparation interval, a wake-up waiting interval, a wake-up preparation interval, or a wake-up preparation period, examples of which are not provided in an exhaustive way in the embodiment.

The wake up interval may be a default wake up interval, or a wake up interval of the terminal device.

In particular, in the case that the above fourth information does not contain the wake up interval of the terminal device, the wake up interval may be the default wake up interval.

It is to be pointed out that the default wake up interval may be used in the following way. In a case that the network device fails to acquire a wake up interval of the terminal device, the network device uses the default wake up interval to determine the second start moment of the paging window corresponding to the terminal device; correspondingly, in a case that the network device side does not store the wake up interval of the terminal device, the network device may preconfigure a default wake up interval for the terminal device in advance, so that the first start moment of the paging window determined by the terminal device is the same as or is substantially the same as a second start position of the paging window determined by the network device. For another example, the default wake up interval may be preset in the network device and the terminal device, as long as the default wake up interval stored in the network device is the same as that stored in the terminal device.

In the case that the above fourth information contains the wake up interval of the terminal device, the wake up interval may be the wake up interval of the terminal device. The wake up interval of the terminal device may be a duration in which the terminal device switches from a first state to a second state, and power consumption of the terminal device in the first state is lower than power consumption of the terminal device in the second state.

It is also to be noted that, the default wake up interval is usually greater than the wake up interval of any terminal device. That is because under the situation that without knowing or obtaining the wake up interval of a terminal device, the network device estimates the second start moment of the paging window in a conservative way (namely using a long default wake up interval), so as to prevent the terminal device from missing detection of the paging message.

The operation S320 that the network device sends the paging message in the paging window may particularly include that the network device sends, to a terminal device, the paging message containing an identifier of the terminal device on at least one paging occasion (PO) in the paging window starting from the second start moment of the paging window. That is to say, in the case that the network device has determined the second start moment of the paging window corresponding to the terminal device, the network device sends, to the terminal device, a paging message containing an identifier of the terminal device on at least one paging occasion (PO) starting from the second start moment of the paging window. It is to be understood that the network device may send paging messages to multiple terminal devices. For example, the network device may send paging messages to the terminal device 1, the terminal device 2 and the terminal device 3. For each terminal device, there will be POs corresponding thereto and a second start moment of a paging window corresponding thereto. With the terminal device 1 as an example, at S310, the network device sends first information to the terminal device 1; correspondingly, at S320, the network device sends a paging message containing an identifier of the terminal device 1 on at least one PO of the terminal device 1 starting from a second start moment of a paging window corresponding to the terminal device 1.

The way in which the network device determines to stop sending the paging message to the terminal device may include that: the network device stops sending to the terminal device the paging message containing the identifier of the terminal device on the at least one PO in the paging window, in a case that a second condition is satisfied.

The particular content of the second condition may differ as relevant information configured for the terminal device change. For example, a total duration of the paging window is preconfigured for the terminal device, or a total amount of time-domain resources is preconfigured for the terminal device. The two approaches are described hereinafter.

Approach I: a total duration of the paging window is preconfigured for the terminal device by the network device.

The second condition includes at least one of following: a sending duration in which the network device sends to the terminal device the paging message containing the identifier of the terminal device on the at least one PO exceeds a total duration of the paging window; or a paging response is received by the network device from the terminal device.

The total duration of the paging window is predetermined and configured for the terminal device by the network device.

In this approach, the PO may particularly be a PO of the terminal device, or an available PO of a cell. Description is made with two cases hereinafter.

First case of approach I: the PO may particularly be a PO of the terminal device. The at least one PO is particularly at least one PO of the terminal device.

The second condition includes at least one of following: a sending duration in which the network device sends to the terminal device the paging message containing the identifier of the terminal device on the at least one PO of the terminal device exceeds a total duration of the paging window; or a paging response is received by the network device from the terminal device.

The operation that the network device determines whether to stop sending the paging message containing the identifier of the terminal device to the terminal device on the at least one PO of the terminal device based on the condition that the sending duration in which the network device sends to the terminal device the paging message containing the identifier of the terminal device on the at least one PO of the terminal device exceeds the total duration of the paging window may particularly include that:
the network device sends to the terminal device the paging message containing the identifier of the terminal device on the at least one PO of the terminal device starting from the second start moment of the paging window corresponding to the terminal device, and records a duration between a current moment and the second start moment as the sending duration; if the sending duration exceeds the total duration of the paging window and the network device receives no paging response from the terminal device, the network device stops sending the paging message containing the identifier of the terminal device to the terminal device on the at least one PO of the terminal device. When such a condition is satisfied, the network device may consider that the paging for the terminal device is not successful this time, and can prepare to wake up and page for the terminal device again, namely S310 and S320 may be performed again.

The operation that the network device determines whether to stop sending the paging message containing the identifier of the terminal device to the terminal device on the at least one PO of the terminal device based on the condition that the network device receives a paging response from the terminal device may particularly include that: the network device sends to the terminal device the paging message containing the identifier of the terminal device on the at least one PO of the terminal device starting from the second start moment of the paging window corresponding to the terminal device, and records a duration between a current moment and the second start moment as the sending duration; in the case that the sending duration does not exceed the total duration of the paging window and the network device receives a paging response from the terminal device, the network device stops sending the paging message containing the identifier of the terminal device to the terminal device on the at least one PO of the terminal device. When such a condition is satisfied, the network device may consider that the paging message containing the identifier of the terminal device is received by the terminal device, and the terminal device may further enter a connected state. The network device and the terminal device perform subsequent operations, which will not be described herein. The paging response may be carried in an RRC connection request.

The network device may determine a PO of the terminal device using the following formula: i_s=Floor(UE_ID/N)mod Ns.

N is the number of PFs contained in a paging DRX period.

Ns is the number of available POs of the cell contained in a PF.

UE_ID is the identifier of the terminal device, and is 5G-S-TMSI mod 1024.

The PO of the terminal device may be composed of multiple PDCCH monitoring occasions. For example, a PO of the terminal device may include X PDCCH monitoring occasions. X is a positive integer, and X is equal to the number of actually transmitted synchronization signal and PBCH blocks (SSBs), which are broadcast in a master information block (MIB).

The position of a PF in a paging DRX period and the identifiers (or indexes) of POs of the terminal device may be determined according to the above formulas. After the terminal device determines the PF, the identifiers (or indexes) of the POs of the terminal device, and the number X of PDCCH monitoring occasions in a PO of the terminal device, the terminal device can determine a particular position of each PO of the terminal device in the time domain by only determining the start position of the 1st PDCCH monitoring occasion of each PO of the terminal device and further in combination with the duration of one PO. The start position of the PDCCH monitoring occasion may be configured by a high-layer signaling, or may be obtained based on the identifiers (or indexes) of the POs of the terminal device. The duration of one PO is the cycle of beam scanning (which may be configured by the system).

After determining the above PF and each of POs of the terminal device, the network device may send the paging message to the terminal device on the POs of the terminal device. Here, it is also to be pointed out that, the network device may send paging messages to multiple terminal devices simultaneously; and thus the network device may carry multiple paging messages for multiple terminal devices in each PO, for example the network device defaults to that paging messages for 16 terminal devices may at most be carried in the paging messages sent on each PO. Correspondingly, each terminal device may monitor and decode a paging message on a respective PO in the PF. The way in which a terminal device receives and detects a paging message for the terminal device has been described above in the method for paging of the terminal device, which will not be described here repeatedly.

### Second Case of Approach I

The second condition includes at least one of following: a sending duration in which the network device sends to the terminal device the paging message containing the identifier of the terminal device on at least one available PO of a cell exceeds the total duration of the paging window; or a paging response is received by the network device from the terminal device.

In this approach, the at least one PO may particularly be an available PO of a cell. That is to say, the at least one PO refers to any one or more POs among all available POs of the cell in the paging window.

The operation that the network device determines whether to stop sending the paging message containing the identifier of the terminal device to the terminal device on the at least one available PO of the cell based on the condition that the sending duration in which the network device sends to the terminal device the paging message containing the identifier of the terminal device on the at least one available PO of the cell exceeds the total duration of the paging window may particularly include that: the network device sends to the terminal device the paging message containing the identifier of the terminal device on the at least one available PO of the cell starting from the second start moment of the paging window corresponding to the terminal device, and records a duration between a current moment and the second start moment of the paging window as the sending duration; in the case that the sending duration exceeds the total duration of the paging window and the network device receives no paging response from the terminal device, the network device stops sending the paging message containing the identifier of the terminal device to the terminal device on the at least one available PO of the cell. When such a condition is satisfied, the network device may consider that the paging for the terminal device is not successful this time, and can prepare to wake up and page for the terminal device again, namely S310 and S320 may be performed again.

The operation that the network device determines whether to stop sending the paging message containing the identifier of the terminal device to the terminal device on the at least one available PO of the cell based on the condition that the network device receives a paging response from the terminal device may particularly include that: the network device sends to the terminal device the paging message containing the identifier of the terminal device on the at least one available PO of the cell starting from the second start moment of the paging window corresponding to the terminal device, and records a duration between a current moment and the second start moment as the sending duration; in the case that the sending duration does not exceed the total duration of the paging window and the network device receives a paging response from the terminal device, the network device stops sending the paging message containing the identifier of the terminal device to the terminal device on the at least one available PO of the cell. When such a condition is satisfied, the network device may consider that the paging message containing the identifier of the terminal device is received by the terminal device, and the terminal device may further enter a connected state. The network device and the terminal device perform subsequent operations, which will not be described herein.

In the present case, the operation that the network device sends to the terminal device the paging message containing the identifier of the terminal device on the at least one available PO of the cell may include: the network device firstly determines all available POs of the cell within the total duration range of the paging window, and then determines, from the all available POs of the cell, one or more available POs of the cell for sending the paging message containing the identifier of the terminal device to the terminal device.

Exemplarily, the way in which the one or more available POs of the cell for sending the paging message containing the identifier of the terminal device to the terminal device are determined from the all available POs of the cell may include any one of following:
one or more available POs of the cell are randomly selected from the all available POs of the cell so as to be used for sending the paging message containing the identifier of the terminal device to the terminal device; or
an available PO of the cell that is earliest and capable of sending the paging message containing the identifier of the terminal device is selected from the all available POs of the cell. Being capable of sending the paging message containing the identifier of the terminal device refers to that the PO is not completely occupied by the paging messages of other terminal devices. For example, the earliest available PO of the cell may carry the paging messages of 16 terminal devices, while only the paging messages of 13 terminal devices have been configured at present; and then this PO may be selected.

In the present case, the terminal device may monitor the paging message on all available POs of the cell starting from the first start moment of the paging window determined by the terminal device. Particular operations of the terminal device have been described in the foregoing embodiments of the method for paging of the terminal device, which will not be described here repeatedly.

Regarding the second case of approach I, it is to be noted that, in the present case, the network device may send the paging message containing the identifier of the terminal device to the terminal device on any one or more available POs of the all available POs of the cell after the first start moment of the paging window. That is to say, the second case differs from the above first case of approach I in that the network device only sends the paging message containing the identifier of the terminal device on the PO of the terminal device itself in the first case.

Description of the available POs of the cell and the way of determining same may be similar to the way in which the terminal device determines the available POs of the cell described above, which will not be described here again.

Regarding the first case and the second case of approach I, it is also to be pointed out that the total duration of the paging window configured for the terminal device by the network device may be the same or may be different in the two cases. For example, the total duration of the paging window configured for the terminal device by the network device in the first case of approach I is L (in unit of time slots, subcarriers, microseconds and so on), and the total duration of the paging window configured for the terminal device by the network device in the second case of approach I is K. L may be the same as or different from K. That is because the network device only sends the paging message containing the identifier of the terminal device to the terminal device on the POs of the terminal device in the first case of approach I, and the network device may send the paging message containing the identifier of the terminal device to the terminal device on any one or more POs of the all available POs of the cell in the paging window in the second case of approach I; and the time interval between POs of the terminal device may be greater than the time interval between available POs of the cell; therefore, the total duration of the paging window configured for the terminal device by the network device in the first case may be slightly greater than that in the second case. Of course, this is merely exemplary description; and it does not mean that the total duration of the paging window in the first case is limited to be necessarily greater than the total duration of the paging window in the second case in practical processing, and it may be smaller than or equal to that in the second case.

Approach II: the terminal device is preconfigured with a total number of time-domain resources by the network device. As explained before, the PO may refer to a PO of the terminal device (which may be referred to as a PO of the terminal device itself hereinafter for convenience of describing the method, which should be understood as the same meaning as a PO of the terminal device), or an available PO of a cell. Description may be made with two cases hereinafter.

### First Case of Approach II

The total number of the time-domain resources is a total number N of POs of the terminal device itself on which the terminal device performs monitoring. The PO is a PO of the terminal device.

The second condition includes at least one of following: a number of POs occupied by the network device to send to the terminal device the paging message containing the identifier of the terminal device exceeds a total number of time-domain resources; or a paging response is received by the network device from the terminal device.

The operation that the network device determines whether to stop sending the paging message to the terminal device based on the condition that the number of POs occupied by the network device to send to the terminal device the paging message containing the identifier of the terminal device exceeds the total number of time-domain resources may include that:
after the second start moment of the paging window corresponding to the terminal device, the network device sends to the terminal device the paging message containing the identifier of the terminal device on the at least one PO of the terminal device, and records a number of POs of the terminal device that have been occupied at present; in the case that the number of POs exceeds the total number of the time-domain resources and the network device receives no paging response from the terminal device, the network device stops sending the paging message to the terminal device. Then, the network device may determine that no paging message containing the identifier of the terminal device is received by the terminal device this time, and further S310 and S320 may be performed again.

The operation that the network device determines whether to stop sending the paging message to the terminal device based on the condition that the network device receives a paging response from the terminal device may particularly include that:
after the second start moment of the paging window corresponding to the terminal device, the network device sends to the terminal device the paging message containing the identifier of the terminal device on the at least one PO of the terminal device, and records a number of POs of the terminal device that have been occupied at present; in the case that the number of POs does not exceed the total number of the time-domain resources and the network device receives a paging response from the terminal device at any moment, the network device stops sending the paging message to the terminal device. That is to say, the network device may stop paging for the terminal device as long as the paging message containing the identifier of the terminal device is received by the terminal device on any of the time-domain resources and the terminal device responds to the network device; in turn, subsequent processing procedures may be performed between the network device and the terminal device, which will not be described again.

The total number of the time-domain resources may be determined by the network device according to the total duration of the paging window. Since the network device per se may determine the total duration of the paging window for sending the paging message to the terminal device and time-domain positions of POs of the terminal device, the number of POs of the terminal device that may be contained in the paging window may be determined thereby. The number of POs of the terminal device that may be contained in the paging window is sent to the terminal device as the total number of the time-domain resources configured for the terminal device this time.

It is to be pointed out that, the total number of the time-domain resources configured for different terminal devices may be the same or may be different. For example, the total number of the time-domain resources configured for the terminal device 1 by the network device may be a, and the total number of the time-domain resources configured for the terminal device 2 by the network device may be n; and a and b are both positive integers, and may be the same as each other or may be different from each other.

### Second Case of Approach II

The PO may be an available PO of a cell. The cell may be a cell where the terminal device is located at present, and more particularly may refer to a serving cell corresponding to the terminal device. The available PO of the cell may particularly be an available PO of the serving cell corresponding to the terminal device. The cell may contain one or more available POs, which are referred to as at least one available PO of the cell hereinafter in the embodiments of the disclosure.

The second condition includes at least one of following: a number of all POs occupied by the network device to send paging messages exceeds a total number of time-domain resources; or a paging response is received by the network device from the terminal device.

The all POs occupied to send the paging messages include the at least one PO occupied to send the paging message containing the identifier of the terminal device. In particular, the all POs occupied to send the paging messages may refer to all available POs of the cell occupied by the network device to send the paging messages each containing an identifier of a respective terminal device to the terminal devices respectively.

By way of example, the network device pages for three terminal devices simultaneously, which are a terminal device 1, a terminal device 2 and a terminal device 3 respectively. All time-domain resources occupied to send the paging messages refer to all available POs of the cell occupied by the network device to send to each of the 3 terminal devices a paging message containing a respective identifier of the terminal device. Moreover, the terminal device 1 to the terminal device 3 may occupy the same available PO of the cell, or may occupy different available POs of the cell. Assuming that the terminal device 1 is the above terminal device of this embodiment, the all time-domain resources occupied to send the paging messages contain any one or more available POs of the cell occupied to send the paging message containing the identifier of the terminal device 1.

Further, the operation that the network device determines whether to stop sending the paging message containing the identifier of the terminal device to the terminal device based on the condition that the number of all POs occupied by the network device to send the paging messages exceeds the total number of time-domain resources may include that:
after the second start moment of the paging window corresponding to the terminal device, the network device sends the paging message containing the identifier of the terminal device on any available PO of the cell, and records a number of available POs of the cell that have been occupied at present; in the case that the number of available POs of the cell exceeds the total number of the time-domain resources and the network device receives no paging response from the terminal device, the network device stops sending the paging message containing the identifier of the terminal device to the terminal device. Then, the network device may determine that no paging message containing the identifier of the terminal device is received by the terminal device this time, and further, the network device may perform S310 and S320 again.

The operation that the network device determines whether to stop sending the paging message containing the identifier of the terminal device to the terminal device based on the condition that the network device receives a paging response from the terminal device may include that: starting from the second start moment of the paging window corresponding to the terminal device, the network device sends the paging message containing the identifier of the terminal device on any available PO of the cell, and records a number of available POs of the cell that have been occupied at present; in the case that the number of available POs of the cell does not exceed the total number of the time-domain resources and the network device receives a paging response from the terminal device, the network device stops sending the paging message containing the identifier of the terminal device to the terminal device. That is to say, the network device may stop paging as long as it determines that the paging message containing the identifier of the terminal device is received by the terminal device on any time-domain resource.

Description of the available POs of the cell and the way of determining same is the same as that in the above embodiments, which will not be described here again.

The total number of the time-domain resources may be configured for the terminal device by the network device. Since the network device per se may determine the total duration of the paging window in which the paging message is sent to the terminal device and time-domain positions of available POs of the cell, the number of all available POs of the cell that may be contained in the paging window may be determined thereby. Then, the number of all available POs of the cell that may be contained in the paging window is sent to the terminal device as the total number of the time-domain resources configured for the terminal device this time.

It is to be pointed out that, the total number of the time-domain resources configured for different terminal devices may be the same or may be different. For example, the total number of the time-domain resources configured for the terminal device 1 by the network device may be c, and the total number of the time-domain resources configured for the terminal device 2 by the network device may be d; and c and d are both positive integers, and may be the same as each other or may be different from each other.

Regarding the first case and the second case of approach II, it should also be understood that, for the same terminal device, the particular numeric value of the total number of time-domain resource configured for the terminal device in the first case may be the same as or may be different from the particular numeric value of the total number of time-domain resource configured for the terminal device in the second case. For example, the particular numeric value of the total number of the time-domain resources configured for the terminal device 1 in the first case of approach II is N (an integer greater than or equal to 1), and the particular numeric value of the total number of the time-domain resources configured for the terminal device 1 in the second case of approach II is M (an integer greater than or equal to 1). N may be greater than M, or may be smaller than M, or may be equal to M.

That is because the network device only sends the paging message containing the identifier of the terminal device to the terminal device on the POs of the terminal device in the first case of approach II, and the network device may send the paging message containing the identifier of the terminal device to the terminal device on any one or more POs of the all available POs of the cell in the paging window in the second case of approach II; and the time interval between POs of the terminal device may be greater than the time interval between available POs of the cell; therefore, the particular numeric value of the total number N of time-domain resources configured for the terminal device 1 by the network device in the first case may be slightly greater than the particular numeric value of the total number M of time-domain resources in the second case. Of course, this is merely exemplary description; and it does not mean that the total number of time-domain resources in the first case is limited to be necessarily greater than the total number of time-domain resources in the second case for the same terminal device in practical processing, and it may be smaller than or equal to that in the second case.

The particular operation that the network device determines the second start moment of the paging window according to the sending moment of the first information and the wake up interval in the case of having sent the first information, and further sends the paging message on at least one PO in the paging window after the second start moment in the paging window has been described in the above embodiments. The relevant operation needing to be performed by the network device before performing S310 and S320 is described hereinafter.

The network device receives second information from a terminal device. The second information includes low power wake up capability information of the terminal device.

After the network device receives the second information from the terminal device, the network device sends third information to a core network device. The third information includes low power wake up capability information of the terminal device. That is to say, the network device reports the low power wake up capability information of the terminal device to the core network device.

Alternatively, after receiving an instruction of acquiring capability information of the terminal device from the core network device, the network device sends a capability information report instruction to the terminal device and then the network device receives the second information from the terminal device. Similarly, the network device sends the third information to the core network device. The third information includes the low power wake up capability information of the terminal device. That is to say, the network device reports the low power wake up capability information of the terminal device to the core network device.

Optionally, the second information may further include a wake up interval of the terminal device. Correspondingly, the third information further includes the wake up interval of the terminal device. That is to say, based on that the terminal device reports the low power wake up capability information of the terminal device to the network device, the terminal device may further report the wake up interval of the terminal device to the network device. After receiving the wake up interval of the terminal device from the terminal device, the network device may report the wake up interval of the terminal device to the core network device. The wake up interval of the terminal device has been particularly explained in the above embodiments, which will not be described here again.

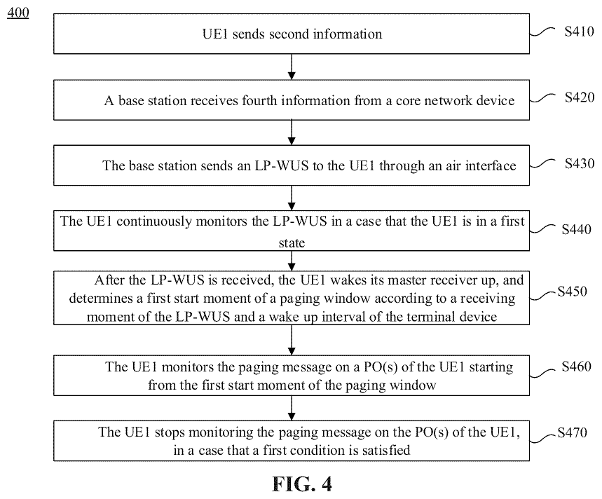

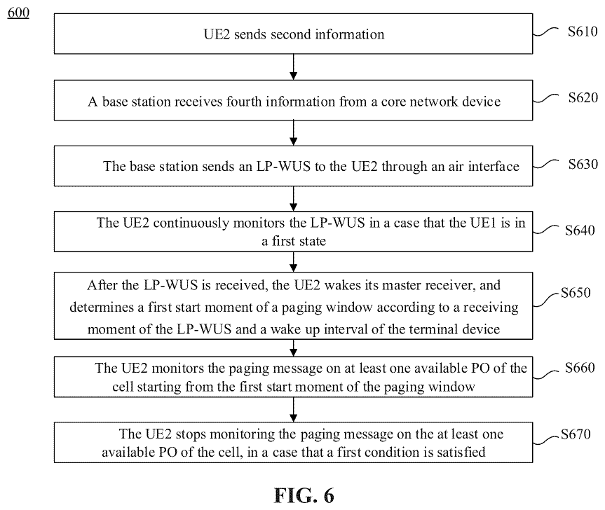

The method for paging of the terminal device and the method for paging of the network device described above are now explained in an exemplary way in combination with FIGS. 4 to 7.

Exemplary method I: description is made with the example that the network device is a base station, the terminal device is UE1, the first information is a low power wake up signal (LP-WUS), the PO is a PO of the UE1, the wake up interval is a wake up interval of the terminal device.

In S410, UE1 sends second information.

This operation needs to be performed in the case that the UE1 is in an RRC connected state at any time.

The second information includes: low power wake up capability information of the UE1, for example, whether the UE1 supports LP-WUS, namely whether the UE1 has an ultra-low power receiver.

Optionally, the UE1 may also report a wake up interval of the terminal device in the second information.

It is to be pointed out that this operation may be initiated by the UE1 actively, or may be performed by the UE1 as instructed. For example, the UE1 may actively send the second information to a base station that the UE1 is connected to at any time when the UE1 is in an RRC connected state. Alternatively, at any time when the UE1 is in an RRC connected state, a core network device may instructs, through the base station that the UE1 is connected to, the UE1 to report capability information of the UE1, and then the UE1 sends the second information to the base station that the UE1 is currently connected to.

After S410 is completed, at any time when the UE1 is in an RRC connected state, namely a master receiver is not in a wakeup state, S420 below and subsequent operations may be performed.

In S420, a base station receives fourth information from a core network device.

It is to be firstly pointed out that, the base station in this operation may be the same or may be different from the base station in S410 mentioned above. That is because the operation S410 of receiving the second information from the UE1 may be performed at any time when the UE1 is in an RRC connected state, and S420 is performed when the core network device needs to initiate paging to the UE1. Therefore, the base station in this operation may be the same or may be different from the base station in S410 mentioned above.

The core network device may be an access and mobility management function (AMF), or may be other devices in a core network. Exemplary description is made in this embodiment, rather than exhaustive listing.

The fourth information may particularly be transmitted through an NG interface. The fourth information may be used by the core network device to trigger the network device to send a paging message to the UE1.

The fourth information may further include low power wake up capability information of the UE1, namely information for indicating whether the UE1 supports an LP-WUS.

Optionally, the fourth information may further include a wake up interval of the terminal device corresponding to the UE1.

In S430, the base station sends an LP-WUS to the UE1 through an air interface.

It is to be pointed out that, if the low power wake up capability information of the UE1 contained in the fourth information in S420 indicates that the UE1 supports low power wake up, then S430 may be performed; otherwise, a normal paging procedure may be used to perform subsequent operations instead of S430, which will not be described here.

After sending the LP-WUS, the base station will also send a paging message containing an identifier of the UE1 to the UE1 starting from a second start moment of a paging window of the UE1. In particular, the base station sends the paging message containing the identifier of the UE1 to the UE1 on a PO(s) of the UE1 starting from the second start moment of the paging window of the UE1. The way in which the base station side determines to stop sending the paging message is the same as that in the first case of approach I or the first case of approach II in the embodiments of the method for paging of the network device above, which will not be described here repeatedly.

The way in which the base station side determines the second start moment of the paging window may include that: a moment that is later than a sending moment of the LP-WUS by the wake up interval of the terminal device corresponding to the UE1 is determined as the second start moment of the paging window.

In S430, the base station may also send an LP-WUS and a paging message to another UE as instructed or triggered by the core network device, and the processing is the same for each UE, except that the second start moment of the paging window, the wake up interval of the terminal device, and POs of the UE may be different for different UE. Therefore, no repeated description is made.

In S440, the UE1 continuously monitors the LP-WUS when the UE1 is in a first state.

In S450, after the LP-WUS is monitored or received, the UE1 wakes up its master receiver, and determines a first start moment of a paging window according to a receiving moment of the LP-WUS and a wake up interval of the terminal device.

Waking up the master receiver of the UE1 may be understood as that the terminal device switches from a first state to a second state. Description of the first state and the second state is the same as that in the embodiments of the method for paging of the terminal device above, which will not be described here again.

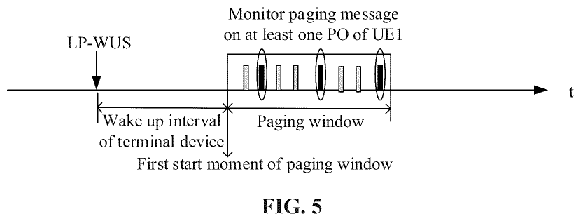

The way of determining the first start moment of the paging window according to the receiving moment of the LP-WUS and the wake up interval may particularly refer to FIG. 5, and may include that: the UE1 determines a moment that is later than the receiving moment of the LP-WUS by the wake up interval of the terminal device as the first start moment of the paging window.

In addition, the UE1 may further receive fifth information (for example, before S460). The fifth information includes a total duration of the paging window or a total number N of time-domain resources. N is an integer greater than or equal to 1. The fifth information is carried by at least one of following: a system message, an RRC dedicated signaling, or DCI.

In S460, the UE1 monitors the paging message on a PO(s) of the UE1 starting from the first start moment of the paging window.

In S470, the UE1 stops monitoring the paging message on the PO(s) of the UE1, in a case that a first condition is satisfied.

When the fifth information includes the total duration of the paging window, the first condition includes: a monitoring duration of monitoring the paging message on at least one PO of the UE1 exceeds the total duration of the paging window and no paging message containing an identifier of the UE1 is received. When the condition is satisfied, the UE1 may return to the first state, namely turn off its master receiver, and monitor an LP-WUS again.

Alternatively, the first condition includes that a paging message containing the identifier of the UE1 is received by the UE1 on a first PO of the UE1. The first PO of the UE1 is one of the at least one PO of the UE1. In such a case, the UE1 determines that the paging message for itself is received, and may further perform subsequent operations, which will not be described herein.

When the fifth information includes the total number N of the time-domain resources, the first condition includes: a number of POs of the UE1 itself on which the UE1 performs monitoring exceeds the total number N of the time-domain resources and no paging message containing the identifier of the UE1 is received. When the condition is satisfied, the UE1 may return to the first state, namely turn off its master receiver, and monitor an LP-WUS again.

Alternatively, the first condition includes that the number of POs of the UE1 on which the UE1 performs monitoring does not exceed the total number N of the time-domain resources and a paging message containing the identifier of the UE1 is received on a second PO of the UE1. In such a case, the UE1 determines that the paging message for itself is received, and may further perform subsequent operations, which will not be described herein.

The POs of the UE1 (or the POs of the UE1 itself) described above may particularly be as illustrated by the black blocks within the elliptical blocks in FIG. 5. In addition, the length of the paging window as illustrated in FIG. 5 is the total duration of the paging window. Other gray blocks in the paging window may be other available POs of the cell.

Particular description of the above first condition of the UE1 is the same as that in the first case of approach I or the first case of approach II in the embodiments of the method for paging of the terminal device described above, which will not be described here repeatedly.

Exemplary method II: description is made with the example that the network device is a base station, the terminal device is UE2, the first information is a low power wake up signal (LP-WUS), the PO is an available PO of a cell, and the wake up interval is a wake up interval of the terminal device.

In S610, UE2 sends second information.

This operation needs to be performed in the case that the UE2 is in an RRC connected state at any time.

The second information includes: low power wake up capability information of the UE2, for example, whether the UE2 supports LP-WUS, namely whether the UE2 has an ultra-low power receiver.

Optionally, the UE2 may also report a wake up interval of the terminal device in the second information.

It is to be pointed out that this operation may be initiated by the UE2 actively, or may be performed by the UE2 as instructed. For example, the UE2 may actively send the second information to a base station that the UE2 is connected to at any time when the UE2 is in an RRC connected state. Alternatively, at any time when the UE2 is in an RRC connected state, a core network device may instructs, through the base station that the UE2 is connected to, the UE2 to report capability information of the UE2, and then the UE2 sends the second information to the base station that the UE2 is currently connected to.

After S610 is completed, at any time when the UE2 is in an RRC connected state, namely a master receiver is not in a wakeup state, S620 below and subsequent operations may be performed.

In S620, a base station receives fourth information from a core network device.

It is to be firstly pointed out that, the base station in this operation may be the same or may be different from the base station in S610 mentioned above. That is because the operation S610 of receiving the second information from the UE2 may be performed at any time when the UE2 is in an RRC connected state, and S620 is performed when the core network device needs to initiate paging to the UE2. Therefore, the base station in this operation may be the same or may be different from the base station in S610 mentioned above.

The core network device may be an access and mobility management function (AMF), or may be other devices in a core network. Exemplary description is made in this embodiment, rather than exhaustive listing.

The fourth information may particularly be transmitted through an NG interface. The fourth information may be used by the core network device to trigger the network device to send a paging message to the UE2, and may carry a paging message containing an identifier of the UE2.

The fourth information may further include low power wake up capability information of the UE2, namely information for indicating whether the UE2 supports an LP-WUS.

Optionally, the fourth information may further include a wake up interval of the terminal device corresponding to the UE2.

In S630, the base station sends an LP-WUS to the UE2 through an air interface.

It is to be pointed out that, if the low power wake up capability information of the UE2 contained in the fourth information in S620 indicates that the UE2 supports low power wake up, then S630 may be performed; otherwise, a normal paging procedure may be used to perform subsequent operations instead of S630, which will not be described here.

After sending the LP-WUS, the base station sends a paging message containing an identifier of the UE2 to the UE2 on any one or more available POs of a cell starting from a second start moment of a paging window of the UE2. The way in which the base station side selects one or more available POs for transmitting the paging message for the UE2 (namely, the paging message containing the identifier of the UE2) and determines to stop sending the paging message is the same as that in the embodiments of the method for paging of the network device above, which will not be described here repeatedly.

The way in which the base station side determines the second start moment of the paging window may include that: a moment that is later than a sending moment of the LP-WUS by the wake up interval of the UE2 is determined as the second start moment of the paging window.

The above base station may also send an LP-WUS and a paging message to another UE as instructed or triggered by the core network device, and the processing is the same for each UE supporting the low power wake up capability, except that the second start moment of the paging window, the wake up interval of the terminal device, and available POs of the cell that may be used may be different for different UE. Therefore, no repeated description is made.

In S640, the UE2 continuously monitors the LP-WUS in a case that the UE1 is in a first state.

In S650, after the LP-WUS is monitored or received, the UE2 wakes up its master receiver, and determines a first start moment of a paging window according to a receiving moment of the LP-WUS and a wake up interval of the terminal device.

Waking up the master receiver of the UE2 may be understood as that the terminal device switches from a first state to a second state. Description of the first state and the second state is the same as that in the embodiments of the method for paging of the terminal device above, which will not be described here again.

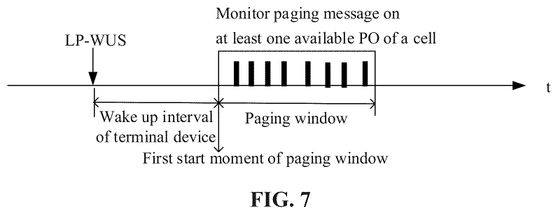

The way of determining the first start moment of the paging window according to the receiving moment of the LP-WUS and the wake up interval may particularly refer to FIG. 7, and may include that: the UE2 determines a moment that is later than the receiving moment of the LP-WUS by the wake up interval of the terminal device as the first start moment of the paging window.

In addition, the UE2 may further receive fifth information. The fifth information includes a total duration of the paging window or a total number M of time-domain resources. M is an integer greater than or equal to 1. The fifth information is carried by at least one of following: a system message, an RRC dedicated signaling, or DCI.

In S660, the UE2 monitors the paging message on at least one available PO of the cell starting from the first start moment of the paging window.

It is to be pointed out that the UE2 may monitor the paging message on all available POs of the cell starting from the first start moment of the paging window, and the base station may send the paging message containing the identifier of the UE2 to the UE2 on any one or more available POs of all available POs of the cell starting from a second start moment of a paging window of the UE2.

In S670, the UE2 stops monitoring the paging message on the at least one available PO of the cell, in a case that a first condition is satisfied.

When the fifth information includes the total duration of the paging window, the first condition includes: a monitoring duration of monitoring the paging message on the at least one available PO of the cell exceeds the total duration of the paging window and no paging message containing an identifier of the UE2 is received. When the condition is satisfied, the UE2 may return to the first state, namely turn off its master receiver, and monitor an LP-WUS again.

Alternatively, the first condition includes that a paging message containing an identifier of the UE2 is received by the UE2 on a first available PO of the cell. The first available PO of the cell is one of the at least one available PO of the cell. In such a case, the UE2 determines that the paging message for itself is received, and may further perform subsequent operations, which will not be described herein.

When the fifth information includes the total number M of the time-domain resources, the first condition includes: a number of available POs of the cell on which the UE2 performs monitoring exceeds the total number M of the time-domain resources and no paging message containing the identifier of the UE2 is received. If the condition is satisfied, the UE2 may return to the first state, namely turn off its master receiver, and monitor an LP-WUS again.

Alternatively, the first condition includes that the number of available POs of the cell on which the UE2 performs monitoring does not exceed the total number M of the time-domain resources and a paging message containing the identifier of the UE1 is received on a second available PO of the cell. In such a case, the UE2 determines that the paging message for itself is received, and may further perform subsequent operations, which will not be described herein.

Particular description of the above first condition of the UE1 is the same as that in the second case of approach I or the second case of approach II in the embodiments of the method for paging of the terminal device described above, which will not be described here repeatedly.

The available POs of the cell described above may particularly be as illustrated by the black blocks in FIG. 7.

The total number N of the time-domain resources and the total number M of the time-domain resources in the two exemplary methods may be the same as each other or different from each other.

Through the above solution, in the case of having sent first information, a network device determines a second start moment of a paging window according to a sending moment of the first information and a wake up interval, and sends a paging message in the paging window. In this way, by determining the window for sending the paging message according to the sending moment of the first information in combination with the wake up interval, the network device is enabled to determine an appropriate occasion on which the terminal device receives the paging message, which can prevent the terminal device from missing receipt of the paging message and avoid the delay problem of the paging message caused by the terminal device waiting for too much time to start the monitoring. Therefore, it can be ensured that the terminal device receives the paging message in a timely manner, thus improving the processing efficiency of the entire system.

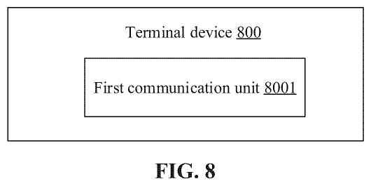

FIG. 8 illustrates a schematic block diagram of a terminal device 800 according to an embodiment of the disclosure. The terminal device 800 may include a first communication unit 8001.

The first communication unit 8001 is configured to receive first information. The first information is a low power wake up signal. The first communication unit 8001 is configured to monitor a paging message in a paging window. A first start moment of the paging window is determined based on a receiving moment of the first information and a wake up interval.

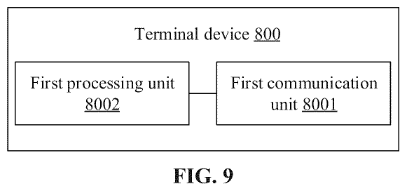

As illustrated in FIG. 9, the terminal device further includes a first processing unit 8002.

The first processing unit 8002 is configured to determine a moment that is later than the receiving moment of the first information by the wake up interval as the first start moment of the paging window.

The wake up interval includes a default wake up interval, or a wake up interval of the terminal device.

The first communication unit 8001 is configured to monitor the paging message on at least one paging occasion (PO) in the paging window starting from the first start moment of the paging window.

The first processing unit 8002 is configured to control the first communication unit to stop monitoring the paging message on the at least one PO in the paging window, in a case that a first condition is satisfied.

The first condition includes at least one of following: a monitoring duration for monitoring the paging message on the at least one PO exceeds a total duration of the paging window; or a paging message containing an identifier of the terminal device has been monitored on a first PO. The first PO is one of the at least one PO.

The total duration of the paging window is configured by a network device.

The first condition includes at least one of following: a number of POs on which monitoring has been performed exceeds a total number of time-domain resources; or a paging message containing an identifier of the terminal device is received on a second PO. The second PO is one of the at least one PO.

The at least one PO is a PO of the terminal device, or an available PO of a cell.

The total number of the time-domain resources is configured by a network device.

The first processing unit 8002 is configured to: control the first communication unit to continuously monitor the first information in a case that the terminal device is in a first state.

The first processing unit 8002 is configured to: switch the terminal device from the first state to a second state in a case that the first information is received. Power consumption of the terminal device in the first state is lower than power consumption of the terminal device in the second state.

The first communication unit 8001 is configured to send second information. The second information includes low power wake up capability information of the terminal device.

The second information further includes a wake up interval of the terminal device.

The wake up interval of the terminal device is a duration in which the terminal device switches from a first state to a second state, and power consumption of the terminal device in the first state is lower than power consumption of the terminal device in the second state.

The first information is a low power wake up signal.

The terminal device 800 according to the embodiment of the disclosure can implement corresponding functions of the terminal device in the above method embodiments. For the procedures, functions, implementations and beneficial effects of the modules (submodules, units, components or the like) in the terminal device 800, reference can be made to the corresponding description in the above method embodiments, which will not be described here again. It is to be noted that, the described functions of the modules (submodules, units, components or the like) in the terminal device 800 according to the embodiments of the disclosure may be realized by different modules (submodules, units, components or the like) or may be implemented by the same module (submodule, unit, component or the like).

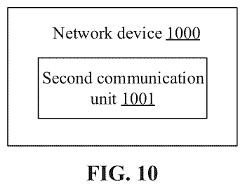

FIG. 10 illustrates a schematic block diagram of a network device 1000 according to an embodiment of the disclosure. The network device 1000 may include a second communication unit 1001.

The second communication unit 1001 is configured to send first information. The first information is a low power wake up signal. The second communication unit 1001 is configured to send a paging message in a paging window. A second start moment of the paging window is determined based on a sending moment of the first information and a wake up interval.

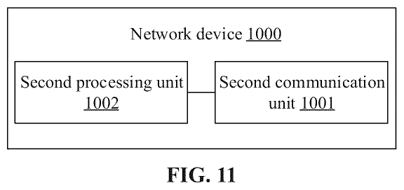

As illustrated in FIG. 11, the network device further includes a second processing unit 1002.

The second processing unit 1002 is configured to determine a moment that is later than the sending moment of the first information by the wake up interval as the second start moment of the paging window.

The wake up interval is a default wake up interval, or a wake up interval of a terminal device.

The second communication unit is configured to: send, to a terminal device, the paging message containing an identifier of the terminal device on at least one paging occasion (PO) in the paging window starting from the second start moment of the paging window.

The second processing unit 1002 is configured to control the second communication unit to stop sending to the terminal device the paging message containing the identifier of the terminal device on the at least one PO in the paging window, in a case that a second condition is satisfied.

The second condition includes at least one of following: a sending duration in which the paging message containing the identifier of the terminal device is sent to the terminal device on the at least one PO exceeds a total duration of the paging window; or a paging response is received from the terminal device.

The at least one PO is a PO of the terminal device, or an available PO of a cell.

The second condition includes at least one of following: a number of POs on which monitoring has been performed exceeds a total number of time-domain resources; or a paging response is received from the terminal device.

The at least one PO is a PO of the terminal device, and the total number of the time-domain resources is a total number N of POs of the terminal device itself on which the terminal device performs monitoring.

The at least one PO is a PO of the terminal device.

The second condition includes at least one of following: a number of all POs occupied by the network device to send paging messages exceeds a total number of time-domain resources; or a paging response is received from the terminal device.

The all POs occupied to send the paging messages include the at least one PO occupied to send the paging message containing the identifier of the terminal device.

The at least one PO is an available PO of a cell.

The second communication unit 1001 is configured to receive second information from the terminal device. The second information includes low power wake up capability information of the terminal device.

The second information further includes a wake up interval of the terminal device.

The second communication unit is configured to send third information to a core network device. The third information includes low power wake up capability information of the terminal device.

The third information further includes a wake up interval of the terminal device.

The second communication unit is configured to receive fourth information from a core network device. The fourth information includes low power wake up capability information of the terminal device.

The fourth information further includes a wake up interval of the terminal device.

The wake up interval of the terminal device is a duration in which the terminal device switches from a first state to a second state, and power consumption of the terminal device in the first state is lower than power consumption of the terminal device in the second state.

The second communication unit is configured to send fifth information to a terminal device. The fifth information includes a total duration of the paging window or a total number of time-domain resources.

The total number of the time-domain resources is determined based on the total duration of the paging window.

The fifth information is carried by at least one of following: a system message, a radio resource control (RRC) dedicated signaling, or downlink control information (DCI).

The first information is a low power wake up signal.

The network device 1000 according to the embodiment of the disclosure can implement corresponding functions of the network device in the above method embodiments. For the procedures, functions, implementations and beneficial effects of the modules (submodules, units, components or the like) in the network device 1000, reference can be made to the corresponding description in the above method embodiments, which will not be described here again. It is to be noted that, the described functions of the modules (submodules, units, components or the like) in the network device 1000 according to the embodiments of the disclosure may be realized by different modules (submodules, units, components or the like) or may be implemented by the same module (submodule, unit, component or the like).

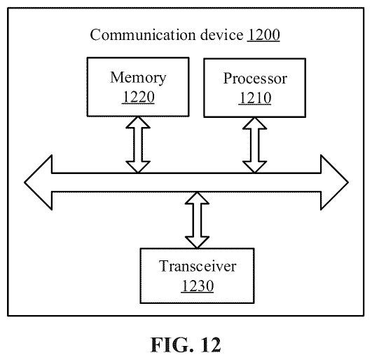

FIG. 12 illustrates a structural diagram of a communication device 1200 according to an embodiment of the disclosure. The communication device 1200 includes a processor 1210. The processor 1210 may call and run a computer program from a memory to enable the communication device 1200 to implement the method according to the embodiments of the disclosure.

In a possible implementation, the communication device 1200 may further include a memory 1220. The processor 1210 may call and run a computer program from the memory 1220 to enable the communication device 1200 implement the method according to the embodiments of the disclosure.

The memory 1220 may be a device independent from the processor 1210, or may be integrated in the processor 1210.

In a possible implementation, the communication device 1200 may further include a transceiver 1230. The processor 1210 may control the transceiver 1230 to communication with other devices, in particular to send information or data to other devices or receive information or data from other device.

The transceiver 1230 may include a transmitter and a receiver. The transceiver 1230 may further include an antenna, and there may be one or more antennas.

In a possible implementation, the communication device 1200 may be the network device of the embodiments of the disclosure, and the communication device 1200 may implement corresponding procedures that are implemented by the network device in various methods according to the embodiments of the disclosure, which is not described here again for simplicity.

In a possible implementation, the communication device 1200 may be a terminal device according to the embodiments of the disclosure, and the communication device 1200 may implement corresponding procedures that are implemented by the terminal device in various methods according to the embodiments of the disclosure, which is not described here again for simplicity.

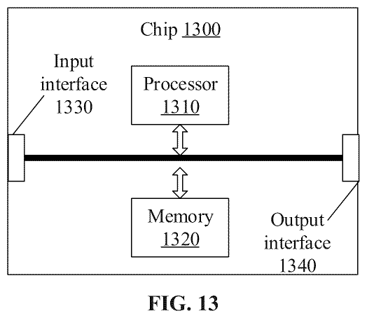

FIG. 13 illustrates a schematic structural diagram of a chip 1300 according to an embodiment of the disclosure. The chip 1300 includes a processor 1310. The processor 1310 may call and run a computer program from a memory to implement the method according to the embodiments of the disclosure.

In a possible implementation, the chip 1300 may further include a memory 1320. The processor 1310 may call and run a computer program from the memory 1320 to implement the method performed by a terminal device or a network device according to the embodiments of the disclosure.

The memory 1320 may be a device independent from the processor 1310, or may be integrated in the processor 1310.

In a possible implementation, the chip 1300 may further include an input interface 1330. The processor 1310 may control the input interface 1330 to communicate with other devices or chips, in particularly to acquire information or data sent by other devices or chips.

In a possible implementation, the chip 1300 may further include an output interface 1340. The processor 1310 may control the output interface 1340 to communicate with other devices or chips, in particularly to output information or data to other devices or chips.

In a possible implementation, the chip may be applied to the network device of the embodiments of the disclosure, and the chip may implement corresponding procedures that are implemented by the network device in various methods according to the embodiments of the disclosure, which is not described here again for simplicity.

In a possible implementation, the chip may be applied to the terminal device according to the embodiments of the disclosure, and the chip may implement corresponding procedures that are implemented by the terminal device in various methods according to the embodiments of the disclosure, which is not described here again for simplicity.

The chip applied to the network device and the terminal device may be the same chip or may be different chips.

It should be understood that, the chip mentioned in the embodiments of the disclosure may also be referred to as a system-level chip, a system chip, a chip system or a system-on-chip.

The above processor may be a general-purpose processor, a digital signal processor (DSP), a field programmable gate array (FPGA), an application specific integrated circuit (ASIC), or another programmable logical device, a transistor logical device, a discrete hardware component and so on. The above-mentioned general-purpose processor may be a microprocessor or may also be any conventional processor and the like.

The memory mentioned above may be a volatile memory or a non-volatile memory, or may include both a volatile memory and a non-volatile memory. The non-volatile memory may be a read-only memory (ROM), a programmable ROM (PROM), an erasable PROM (RPROM), an electrically RPROM (EEPROM), or a flash memory. The volatile memory may be a random access memory (RAM).

It should be understood that the memories are exemplary but not limiting description. For example, the memory in the embodiments of the disclosure may also be a static RAM (SRAM), a dynamic RAM (DRAM), a synchronous DRAM (SDRAM), a double data rate SDRAM (SSD SDRAM), an enhanced SDRAM (ESDRAM), a synch link DRAM (SLDRAM), or a direct Rambus RAM (DR RAM). That is to say, the memory in the embodiments of the disclosure is intended to include but not limited to memories of these and any other suitable types.

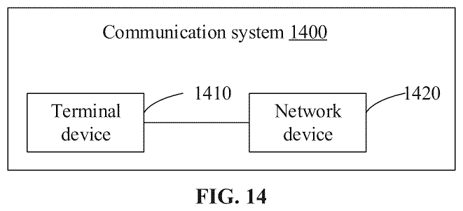

FIG. 14 illustrates a schematic block diagram of a communication system 1400 according to embodiments of the disclosure. The communication system 1400 includes a terminal device 1410 and a network device 1420.

The terminal device receives first information. The first information is a low power wake up signal.

The terminal device monitors a paging message in a paging window. A first start moment of the paging window is determined based on a receiving moment of the first information and a wake up interval.

The network device sends first information. The first information is a low power wake up signal.

The network device sends a paging message in a paging window. A second start moment of the paging window is determined based on a sending moment of the first information and a wake up interval.

The terminal device 1410 may implement corresponding functions implemented by the terminal device in the above methods, and the network device 1420 may implement corresponding functions implemented by the network device in the above methods, which is not described here again for simplicity.

In embodiments of the disclosure, upon receiving first information, a terminal device determines a first start moment of a paging window according to a receiving moment of the first information and a wake up interval, and monitors a paging message in the paging window. In this way, by determining the window for monitoring the paging message according to the receiving moment of the first information in combination with the wake up interval, the terminal device is enabled to determine an appropriate occasion on which the paging message is received, which can prevent the terminal device from missing receipt of the paging message and avoid the delay problem of the paging message caused by the terminal device waiting for too much time to start the monitoring. Therefore, it can be ensured that the terminal device receives the paging message in a timely manner, thus improving the processing efficiency of the entire system.

The above embodiments may be implemented by software, hardware, firmware or any combination thereof completely or in part. When software is used, the embodiments may be implemented in form of a computer program product completely or in part. The computer program product includes one or more computer instructions. The computer program instructions, when loaded and executed by a computer, produce the procedures or functions according to the embodiments of the disclosure completely or in part. The computer may be a universal computer, a dedicated computer, a computer network, or other programmable devices. The computer instructions may be stored in a computer-readable storage medium, or may be transmitted from a computer-readable storage medium to another computer-readable storage medium, for example, the computer instructions may be transmitted from a network station, computer, server or data center to another network station, computer, server or data center in a wired (for example, coaxial cable, fiber, digital subscriber line (DSL)) or wireless (for example, infrared, radio, microwaves) way. The computer-readable storage medium may be any available medium accessible by a computer or may be a data storage device containing a servers, a data center or the like integrated by one or more available mediums. The available medium may be a magnetic medium (for example, a floppy disk, a hard disk, and a magnetic tape), an optical medium (for example, a digital video disks (DVD)), a semiconductor medium (for example a solid state disk (SSD), or the like.

It is to be understood that, in the embodiments of the disclosure, the sizes of the serial numbers of the above operations do not imply the sequential order in which the operations are performed, and shall not construe any limitation to the implementation of the embodiments of the disclosure. The order in which the operations are performed should be decided by their functions and internal logics.

Those skilled in the art may clearly appreciate that for convenience and simplicity of description, the particular operation procedures of the system, apparatus and units described above may refer to corresponding procedures in the foregoing method embodiment, which will not be described herein again.

The above is merely detailed implementations of the disclosure, but the scope of protection of the disclosure is not limited thereto. Any person skilled in the art may easily think of changes or substitutions within the technical scope disclosed in the present disclosure, which shall fall within the scope of protection of the disclosure. Therefore, the scope of protection of the disclosure shall be subjected to the claimed scope of the claims.

1. A method for paging, comprising:
receiving, by a terminal device, first information, wherein the first information is a low power wake up signal; and
monitoring, by the terminal device, a paging message in a paging window, wherein a first start moment of the paging window is determined based on a receiving moment of the first information and a wake up interval.

2. The method of claim 1, further comprising:
determining, by the terminal device, a moment that is later than the receiving moment of the first information by the wake up interval as the first start moment of the paging window.

3. The method of claim 1, wherein monitoring, by the terminal device, the paging message in the paging window comprises:
monitoring, by the terminal device, the paging message on at least one paging occasion (PO) in the paging window, starting from the first start moment of the paging window.

4. The method of claim 3, further comprising:
stopping, by the terminal device, monitoring the paging message on the at least one PO in the paging window, in a case that a first condition is satisfied.

5. The method of claim 4, wherein the first condition comprises at least one of following:
a number of POs on which the terminal device has performed monitoring exceeds a total number of time-domain resources; or
a paging message containing an identifier of the terminal device is received by the terminal device on a second PO, wherein the second PO is one of the at least one PO.

6. The method of claim 3, wherein:
the at least one PO is a PO of the terminal device, or an available PO of a cell.

7. The method of claim 1, further comprising:
continuously monitoring, by the terminal device, the first information in a case that the terminal device is in a first state.

8. A terminal device, comprising:
a transceiver, configured to: receive first information, wherein the first information is a low power wake up signal; and monitor a paging message in a paging window, wherein a first start moment of the paging window is determined based on a receiving moment of the first information and a wake up interval.

9. The terminal device of claim 8, further comprising:
a processor, configured to determine a moment that is later than the receiving moment of the first information by the wake up interval as the first start moment of the paging window.

10. The terminal device of claim 8, wherein the transceiver is configured to monitor the paging message on at least one paging occasion (PO) in the paging window, starting from the first start moment of the paging window.

11. The terminal device of claim 10, wherein the processor is further configured to:
control the transceiver to stop monitoring the paging message on the at least one PO in the paging window, in a case that a first condition is satisfied.

12. The terminal device of claim 11, wherein the first condition comprises at least one of following:
a number of POs on which monitoring has been performed exceeds a total number of time-domain resources; or
a paging message containing an identifier of the terminal device is received on a second PO, wherein the second PO is one of the at least one PO.

13. The terminal device of claim 10, wherein the at least one PO is a PO of the terminal device, or an available PO of a cell.

14. The terminal device of claim 8, wherein the processor is further configured to:
control the transceiver to continuously monitor the first information in a case that the terminal device is in a first state.

15. A network device, comprising:
a transceiver, configured to: send first information, wherein the first information is a low power wake up signal; and send a paging message in a paging window, wherein a second start moment of the paging window is determined based on a sending moment of the first information and a wake up interval.

16. The network device of claim 15, further comprising:
a processor, configured to: determine a moment that is later than the sending moment of the first information by the wake up interval as the second start moment of the paging window.

17. The network device of claim 15, wherein the transceiver is configured to: send, to a terminal device, the paging message containing an identifier of the terminal device on at least one paging occasion (PO) in the paging window, starting from the second start moment of the paging window.

18. The network device of claim 17, wherein the processor is further configured to:
control the transceiver to stop sending to the terminal device the paging message containing the identifier of the terminal device on the at least one PO in the paging window, in a case that a second condition is satisfied.

19. The network device of claim 18, wherein the second condition comprises at least one of following:
a number of POs occupied to send to the terminal device the paging message containing the identifier of the terminal device exceeds a total number of time-domain resources; or
a paging response is received from the terminal device.

20. The network device of claim 19, wherein the at least one PO is a PO of the terminal device.
